(19) United States
(12) Patent Application Publication
(10) Pub. No.: US 2024/0067792 A1
(43) Pub. Date: Feb. 29, 2024

(54) Non-Thermal Plasma Based Deconstruction of Polymers

(71) Applicant: IOWA STATE UNIVERSITY RESEARCH FOUNDATION, INC., Ames, IA (US)

(72) Inventors: Xianglan BAI, Ames, IA (US); Lusi A, Valencia, CA (US); Harish RADHAKRISHNAN, Ames, IA (US)

(21) Appl. No.: 18/451,482

(22) Filed: Aug. 17, 2023

Related U.S. Application Data
(60) Provisional application No. 63/399,106, filed on Aug. 18, 2022.

(51) Int. Cl. C08J 11/06; C08F 8/06; C08F 8/50

(52) U.S. Cl. CPC C08J 11/06; C08F 8/06; C08F 8/50

(57) ABSTRACT

One aspect of the present application relates to a method of decomposing a polymeric reactant. This method comprises reacting the polymeric reactant in an oxygen containing ionized gas plasma to decompose the polymeric reactant and produce oxygen-functionalized products. The reacting is carried out at a temperature of 20 to 450° C. Another aspect of the present application relates to a method of removing carbon dioxide and/or carbon monoxide from a gas mixture. This method comprises providing a gas mixture comprising carbon dioxide and/or carbon monoxide. The gas mixture is contacted with a polymeric reactant in an ionized gas plasma to remove carbon dioxide and/or carbon monoxide from the gas mixture and produce oxygen-functionalized products.

This application claims the benefit of U.S. Provisional Patent Application Ser. No. 63/399,106, filed Aug. 18, 2022, which is hereby incorporated by reference in its entirety.

This invention was made with government support under grant number DE-EE0009943 awarded by Department of Energy. The government has certain rights in the invention.

### FIELD

The present application relates to the non-thermal plasma based deconstruction of polymers.

### BACKGROUND

Although the invention of plastics has greatly improved the quality of human life, the disposal of end-of-life plastics has created significant environmental concerns. Global plastic production increases at an annual rate of approximately 8.4% and the amount is estimated to reach 500 million tons in 2025. It is reported that 6.3 billion tons out of the 8.3 billion tons of virgin plastics produced between 1950 and 2015 became waste plastics (Geyer et al., “Production, Use, and Fate of All Plastics Ever Made,” Sci. Adv. 3: e1700782 (2017)). Of the plastic wastes, 12% was incinerated and 79% ended up in landfills or the natural environment. It is estimated that, by 2050, approximately 12 billion tons of plastic wastes would be disposed in landfills or in the natural environment. Polyolefins are the most common plastics, accounting for nearly two-thirds of total plastic production. From consumer goods to industrial materials, polyolefins are found nearly everywhere. Currently, only 10% of high-density polyethylene (HDPE), 6% of low-density polyethylene (LDPE), and 1% of polypropylene (PP) are recycled (H. Li et al., “Expanding Plastics Recycling Technologies: Chemical Aspects, Technology Status and Challenges,” Green Chemistry 24: 8899-9002 (2022)), with the rest of the waste plastics designated for landfills. These non-polar polymers are difficult to degrade in nature and can remain on the ground and in waterbody for over a hundred years. Plastics can be recycled through incineration, mechanical methods, and chemical approaches. Chemical recycling of plastics has advantages since it deconstructs the polymer chains of waste plastics into platform chemicals, which can re-enter value chains. Plastics can be converted to liquid products via pyrolysis and solvent-based liquefaction. However, deconstruction by these thermochemical methods is often energy intensive, attributed by thermally stable C—C bonds in polyolefins and other plastics. Thermal deconstruction of polyolefins by pyrolysis usually requires temperatures above 550° C., producing a mixture of olefins, paraffin, and aromatics with a wide range of molecular weights requiring subsequent catalytic upgrading (H. Li et al., “Expanding Plastics Recycling Technologies: Chemical Aspects, Technology Status and Challenges,” Green Chemistry 24: 8899-9002 (2022); J. Scheirs and W. Kaminsky, Feedstock Recycling and Pyrolysis of Waste Plastics, J. Wiley & Sons (2006)). Although catalytic hydrogenation or oxidative depolymerization has higher product selectivity, the requirements for catalysts, reactive gases, harsh solvents, high reactor pressure, and long reaction time can hamper the pathway (H. Li et al., Expanding Plastics Recycling Technologies: Chemical Aspects, Technology Status and Challenges,” Green Chemistry 24, 8899-9002 (2022); J. Scheirs and W. Kaminsky, Feedstock Recycling and Pyrolysis of Waste Plastics, J. Wiley & Sons (2006)). Catalyst positioning and deactivation are also problematic when waste plastics with impurities are converted. With photocatalytic and electrochemical conversions, plastic solubility issues and slow reaction rates are barriers (Karimi Estahbanati et al., “Current Developments in the Chemical Upcycling of Waste Plastics Using Alternative Energy Sources,” ChemSusChem 14: 4152-4166 (2021)). Solvent liquefaction also requires the product and solvent separation, increasing the process complexity. Thus, it is essential to find an efficient process to cleave chemical bonds in plastics using reduced energy, and improve the quality of deconstructed products for downstream applications. In this regard, plasma-based technology may provide a promising alternative to thermochemical conversion. When a high electric field is applied to a neutral gas, partially ionized gas containing electrons, protons, radicals, ions, atoms, and molecules is generated. Previously, a two-stage method has been used to convert high-density polyethylene (HDPE), in which HDPE was first pyrolyzed at 500-700° C. and the pyrolysis vapor was subsequently cracked into hydrocarbon gases containing ethylene by applying inert gas plasma (Phan et al., “Monomer Recovery through Advanced Pyrolysis of Waste High Density Polyethylene (HDPE),” Green Chem., 20: 1813-1823 (2018)). Recently, Li et al. employed a CO₂ plasma jet with a plasma temperature between 660° C. and 920° C. to convert low-density PE (LDPE) to gases containing CO, H₂, and light hydrocarbons (CH₄, C₂H₄, and C₂H₆) (Li et al., “Feasibility Test of a Concurrent Process for CO₂ Reduction and Plastic Upcycling Based on CO₂ Plasma Jet,” Journal of CO₂ Utilization, 52: 101701-101706 (2021)). Both methods demonstrate the use of non-thermal plasma to convert polyolefins to smaller hydrocarbons gases, but require very high temperatures.

The present application is directed to overcoming these and other deficiencies in the art.

### SUMMARY

One aspect of the present application relates to a method of decomposing a polymeric reactant. This method comprises reacting the polymeric reactant in an oxygen containing ionized gas plasma to decompose the polymeric reactant and produce oxygen-functionalized products. The reacting is carried out at a temperature of 20 to 450° C.

Another aspect of the present application relates to a method of removing carbon dioxide and/or carbon monoxide from a gas mixture. This method comprises providing a gas mixture comprising carbon dioxide and/or carbon monoxide. The gas mixture is contacted with a polymeric reactant in an ionized gas plasma to remove carbon dioxide and/or carbon monoxide from the gas mixture and produce oxygen-functionalized products.

The present application describes a highly selective non-catalytic upcycling of plastics to chemicals using CO₂ enabled by low-temperature plasma. Specifically, a low-temperature plasma was used to co-convert polyolefins and CO₂ into valuable chemicals in a single step under atmospheric pressure. By employing CO₂, CO, air, oxygen, or mixed gases containing any of these gases as the plasma gas, polymers are oxidatively deconstructed at low temperatures to produce carboxylic acids, alcohols, esters, ethers, and/or other oxygenated products. These chemicals with rich functional groups will broaden the utilization of waste polymers for various chemical and biological applications. Fossil fuel-derived CO₂ emission into the atmosphere is the major contributor to the increasing global greenhouse gas responsible for climate change. Although CO₂ can be an abundant, low-cost carbon source, its chemical utilization is challenging due to the extremely stable C—O bond. The approach disclosed herein applies the electric field to a reactor containing CO₂, CO, air, oxygen, or mixed gases containing any of these gases and plastics to generate plasma discharge. Benefiting from the electron collision and chemically reactive species generated by plasma discharge, thermodynamically unfavored deconstructions of plastics and CO₂ conversion could take place at ambient pressure and much lower temperatures than conventional thermochemical reactions (Diaz-Silvarrey et al., “Monomer Recovery Through Advanced Pyrolysis of Waste High Density Polyethylene (HDPE),” Green Chemistry 20: 1813-1823 (2018); Kang et al., “Feasibility Test of a Concurrent Process for CO₂ Reduction and Plastic Upcycling Based on CO₂ Plasma Jet,” Journal of CO₂ Utilization 52: 101701 (2021), Bäckström et al., “Trash to Treasure: Microwave-Assisted Conversion of Polyethylene to Functional Chemicals,” Industrial & Engineering Chemistry Research 56: 14814-14821 (2017); which are hereby incorporated by reference in their entirety). Inside the plasma reactor, CO₂-derived species could act as a powerful cracking agent, oxidant, and carbon source to oxidatively depolymerize polyolefins to liquids rich in oleochemicals such as fatty alcohols and fatty acids. It was discovered that supplementing CO₂ with a small amount of O₂ can dramatically increase product selectivity, achieving 97.6 wt % of fatty alcohols from high-density polyethylene (PE) using a single step without catalysts. Fatty alcohols have broader industrial applications, such as cosmetics, detergents, surfactants, solvents, lubricants, fuels, and pharmaceuticals (Munkajohnpong et al., “Fatty Alcohol Production: An Opportunity of Bioprocess,” Biofuels, Bioproducts and Biorefining 14: 986-1009 (2020); Wittcoff et al., Industrial Organic Chemicals, John Wiley & Sons (2012); which are hereby incorporated by reference in their entirety). The global market of fatty alcohols was around $7 billion in 2017 and was estimated to reach $10 billion in 2023, while current synthesis methods are reliant on palm oils or petrochemicals, causing increased carbon emissions (Munkajohnpong et al., “Fatty Alcohol Production: An Opportunity of Bioprocess,” Biofuels, Bioproducts and Biorefining 14: 986-1009 (2020), which is hereby incorporated by reference in its entirety). Notably, the US market price of fatty alcohols was $2500-3000/MT in 2022. Other products derivable from the co-conversion of PE and CO₂, such as fatty acids, can be used in the production of emulsifiers and food additives, while olefins and paraffins can be used as raw materials for petrochemicals, fuels, and lubricants (H. Li et al., Expanding Plastics Recycling Technologies: Chemical Aspects, Technology Status and Challenges,” Green Chemistry 24, 8899-9002 (2022); Wittcoff et al., Industrial Organic Chemicals, John Wiley & Sons (2012); which are hereby incorporated by reference in their entirety). Furthermore, this plasma-based co-conversion approach can synergistically increase CO₂ conversion to produce CO as the major gas product in addition to the chemicals. The co-conversion was also demonstrated using post-consumer waste PE (PC-PE), showing the promising potential of the proposed approach. This plasma-based co-upcycling concept is illustrated in FIG. 1.

This non-catalytic, low-temperature plasma-based method can be used to chemically upcycle plastics while concurrently utilizing CO₂ or CO. While chemical upcycling of plastics and CO₂ and CO utilization are attractive, dissociating C—C bonds in plastic polymers or activating CO₂ or CO molecules are energy intensive. By applying CO₂ plasma discharge to high-density polyethylene (HDPE), polyethylene (PE) was converted using low temperatures while producing over 100% oxygenated liquid products (per initial PE mass) containing olefins, paraffins, carboxylic acids, alcohols, and other carbonyls. During the plasma assisted co-conversion of PE and CO₂, electrons and reactive plasma species of CO₂ promote bond cleaving of plastics, whereas PE acts as a sink to chemically quench CO₂ plasma species to produce useful chemicals. Although plasma reactions are commonly known for their extreme complexity, supplementing CO₂ with a small amount of O₂ drastically improved the product selectivity of the co-conversion without needing catalysts or solvents. Based on this approach, as high as 97.6 wt % of fatty alcohols from high-density polyethylene was achieved in a single step. This work suggests that while CO₂ plasma species serve as oxidant and carbon sources to enable oxidative depolymerization of plastics under mild conditions, the plastics act as scavengers to synergistically increase CO₂ conversion to produce CO as the major gas product in addition to high yields of oleochemicals. The applicability of this approach was demonstrated using post-consumer waste plastics, providing a promising opportunity for truly green and circular carbon upcycling of waste plastics and CO₂ sequestration to obtain sustainable platform chemicals using renewable electricity.

### BRIEF DESCRIPTION OF THE DRAWINGS

FIG. 1 illustrates the concept of co-upcycling of waste plastics and CO₂ based on low-temperature plasma. In this approach, CO₂ acts as an oxidant and carbon source to oxidatively depolymerize polyolefins to platform chemicals, whereas plastics act as scavengers to increase CO₂ conversion. Using O₂ as a supplemental gas, fatty alcohols can be selectively produced from polyethylene.

FIGS. 2A-C show solid and liquid yields (per PE mass) as a function of plasma treatment time for Air plasma (FIG. 2A), CO₂ plasma (FIG. 2B), and Argon plasma (FIG. 2C). Electricity voltage: 15 kV; electricity frequency: 8 kHz; gas flow rate: 50 mL/min, initial reactor temperature: 350° C.

FIGS. 3A-C show the selectivity of functional groups in liquids as a function of plasma treatment time for Air plasma (FIG. 3A), CO₂ plasma (FIG. 3B), and Argon plasma (FIG. 3C). Electricity voltage: 15 kV; electricity frequency: 8 kHz; gas flow rate: 50 mL/min, initial reactor temperature: 350° C.

FIG. 4 shows the effect of initial reactor temperature on temperature profile of reactor. Plasma treatment conditions: voltage of 15 kV, frequency of 8 kHz, CO₂ gas flow rate of 50 mL/min.

FIGS. 5A-B show the effect of initial reactor temperature on product distribution at 300° C. (FIG. 5A) and 400° C. (FIG. 5B). Plasma treatment conditions: voltage of 15 kV, frequency of 8 kHz, CO₂ gas flow rate of 50 mL/min. The result of the 350° C. case is given in FIG. 2B.

FIGS. 6A-B show the effect of initial reactor temperature on selectivity of functional groups in liquids at 300° C. (FIG. 6A) and 400° C. (FIG. 6B). Plasma treatment conditions: voltage of 15 kV, frequency of 8 kHz, CO₂ gas flow rate of 50 mL/min. The result of the 350° C. case is given in FIG. 3B.

FIG. 7 shows the oxygen content in products. Plasma treatment conditions: voltage of 15 kV, frequency of 8 kHz, CO₂ gas flow rate of 50 mL/min.

FIG. 8 shows a schematic diagram of the plasma-based conversion system setup. 1—gas cylinders; 2—high-voltage plasma power supply; 3—plasma reactor; 4—oscilloscope; 5—high-voltage probe; 6—current probe; 7—condenser; and 8—micro-GC.

FIGS. 9A-C show pictures of liquid product from PE conversion by CO₂ plasma stored at room temperature (FIG. 9A), the liquid product shown in FIG. 9A heated to 80° C. (FIG. 9B), and the liquid product dissolved in a mixture of toluene and pyridine (FIG. 9C). The reaction times for producing the liquids are given.

FIGS. 10A-B show plasma-based conversion of plastics and CO₂. FIG. 10A provides reaction time-dependent product yields and CO₂ conversion when PE was converted using different inlet gas compositions and gas residence time: (i) CO₂, t_{R}=13s (corresponds to a gas flow rate of 50 mL/min), (ii) CO₂, t_{R}=20s (a flow rate of 32.5 mL/min), (iii) CO₂ and 8 vol % O₂, t_{R}=13s, (vi) argon, t_{R}=13s, and (v) air, t_{R}=13s. Product yield is calculated based on the initial mass of PE. FIG. 10B provides reaction time-dependent gas product selectivity and PE-derivable gas (i.e., hydrocarbons and hydrogen) yield with different plasma conditions: (i) CO₂, t_{R}=13s, (ii) CO₂, t_{R}=20s, and (iii) CO₂/O₂, t_{R}=13s. In all the tests, other reaction conditions are electricity voltage (V)=15 kV, frequency (f)=8 kHz, and initial reactor temperature (Tᵢ)=350° C., unless specified.

FIG. 11 shows a cross-section view of plasma gas discharges for argon, air, CO₂ and CO₂/O₂ without plastics inside. Reaction conditions: voltage (V)=15 kV, frequency (f)=8 kHz, and t_{R}=13s.

FIGS. 12A-C show high-temperature gas chromatography with mass spectrometry and flame ionization detector (HT-GC/FID) chromatograms of PE-derived liquids produced using CO₂ plasma and t_{R}=13s (FIG. 12A); CO₂ plasma and t_{R}=20s (FIG. 12B); CO₂/O₂ plasma and t_{R}=13s (FIG. 12C). Other reaction conditions are the same in all the cases, which are 15 kV, 8 kHz, and 10 min. The shift in the peaks to lower retention time is due to overall lower molecular weights of the compounds.

FIGS. 13A-C provide PE-derived liquid product characterizations showing mass yield (FIG. 13A) and liquid selectivity (FIG. 13B) of products with different functional groups, and selectivity of fatty alcohols with four different carbon number ranges (FIG. 13C). All were obtained using (i) CO₂ plasma, t_{R}=13s, (ii) CO₂ plasma, t_{R}=20s, and (iii) CO₂/O₂ plasma, t_{R}=13s. The product yields are per initial PE mass basis and liquids are obtained with a 10 min reaction time for all cases.

FIG. 14 shows mass yield of compounds with functional groups obtained from PE conversion by air plasma and t_{R}=13s. Other reaction conditions: 15 kV, 8 kHz, and 15 min.

FIG. 15 provides ¹³C NMR spectra of liquid products obtained using (i) CO₂ plasma, t_{R}=20s, and (ii) CO₂/O₂ plasma, t_{R}=13s. Chloroform-d (CDCl₃) peak between chemical shifts 75 and 80 was hidden to improve the visibility of desired peaks. The liquids are obtained with a 10 min reaction time for all cases.

FIGS. 16A-F show time-dependent liquid and solid yields (per plastic feedstock mass) for converting PE using CO₂ plasma, 13s, 12.5 kV, 8 kHz (FIG. 16A); CO₂ plasma, 13s, 17.5 kV, 8 kHz (FIG. 16B); CO₂ plasma, 13s, 15 kV, 7.5 kHz (FIG. 16C); CO₂ plasma, 13s, 15 kV, 8.5 kHz (FIG. 16D); CO₂ plasma, 10s, 15 kV, 8 kHz (FIG. 16E); CO₂/O₂ plasma, 20s, 15 kV, 8 kHz (FIG. 16F). CO₂ conversion in FIG. 16A is not provided due to low conversion.

FIGS. 17A-E show time-accumulated gas product selectivity and PE-derivable gas (hydrocarbons and H₂) yield calculated per PE feedstock mass when PE is converted using CO₂ plasma, 13s, 17.5 kV, 8 kHz, 7.5 min (FIG. 17A); CO₂ plasma, 13s, 15 kV, 7.5 kHz, 10 min (FIG. 17B); CO₂ plasma, 13s, 15 kV, 8.5 kHz, 10 min (FIG. 17C); CO₂ plasma, 10s, 15 kV, 8 kHz, 12.5 min (FIG. 17D); and CO₂/O₂ plasma, 20s, 15 kV, 8 kHz, 7.5 min (FIG. 17E).

FIGS. 18A-E show mass selectivity of functional group compounds in liquids obtained from converting PE using CO₂ plasma, 13s, 17.5 kV, 8 kHz, 7.5 min (FIG. 18A); CO₂ plasma, 13s, 15 kV, 7.5 kHz, 10 min (FIG. 18B); CO₂ plasma, 13s, 15 kV, 8.5 kHz, 10 min (FIG. 18C); CO₂ plasma, 10s, 15 kV, 8 kHz, 12.5 min (FIG. 18D); CO₂/O₂ plasma, 20s, 15 kV, 8 kHz, 7.5 min (FIG. 18E).

FIG. 19 shows CO₂ conversion compared for converting CO₂ without and with PE under different plasma conditions. Cumulative CO₂ conversion after complete PE conversion is reported.

FIG. 20 shows synergic interactions between PE and CO₂ during their plasma-based co-conversion, providing a comparison of CO₂ conversion without or with plastics placed inside plasma reactor.

FIG. 21 shows mass spectra of 5-octadecene (C₁₈H₃₆, Mw=252) compared between ¹³CO₂ plasma-based (upper) and regular (lower) molecules.

FIG. 22 shows mass spectra of allyl alcohol, TMS derivative (C₆H₁₀OSi, Mw=130) compared between ¹³CO₂ plasma-based (upper) and regular (lower) molecules.

FIG. 23 shows mass spectra of palmitic acid, TMS derivative (C₁₉H₄₀O₂Si, Mw=328) compared between ₁₃CO₂ plasma-based (upper) and regular (lower) molecules.

FIG. 24 shows mass spectra of Arachidonic acid, TMS derivative (C₂₃H₄₀O₂Si, Mw=376) compared between ¹¹³CO₂ plasma-based (upper) and regular (lower) molecules.

FIG. 25 shows mass spectra of 9-octadecanone (C₁₈H₃₆O₁, Mw=268) compared between ¹³CO₂ plasma-based (upper) and regular (lower) molecules.

FIG. 26 provides proposed reaction pathways during plasma co-conversion of PE and CO₂.

FIG. 27 illustrates the mass balance of the co-conversion systems including all reactants and measured products with (i) CO₂ plasma, t_{R}=20s, and (ii) CO₂/O₂ plasma, t_{R}=13s.

FIGS. 28A-B provide pictures of virgin PE (FIG. 28A) and post-consumer PE (PC-PE) (FIG. 28B) used in this work.

FIG. 29 shows application aspects of plasma-based co-upcycling of plastics and CO₂ showing conversion of PC-PE using CO₂/O₂ plasma (t_{R}=13s) (i) Mass yield and liquid selectivity of different functional group products, and (ii) selectivity of fatty alcohols with four different carbon number ranges. The initial reactor temperature is 325° C. and the reaction time is 10 min.

FIG. 30 shows PC-PE conversion using CO₂/O₂ plasma. Gas products selectivity and the PC-PE-derivable gas yield are provided (the dashed line is the sum yield of hydrocarbons and hydrogen gases). Reaction conditions: 13s, 15 kV, 8 kHz, 10 min, initial temperature: 325° C.

FIG. 31 shows application aspects of plasma-based co-upcycling of plastics and CO₂ showing mass balance of the co-conversion systems including all reactants and measured products when PC-PE was converted using CO₂/O₂ plasma, t_{R}=13s. The initial reactor temperature is 325° C. and the reaction time is 10 min.

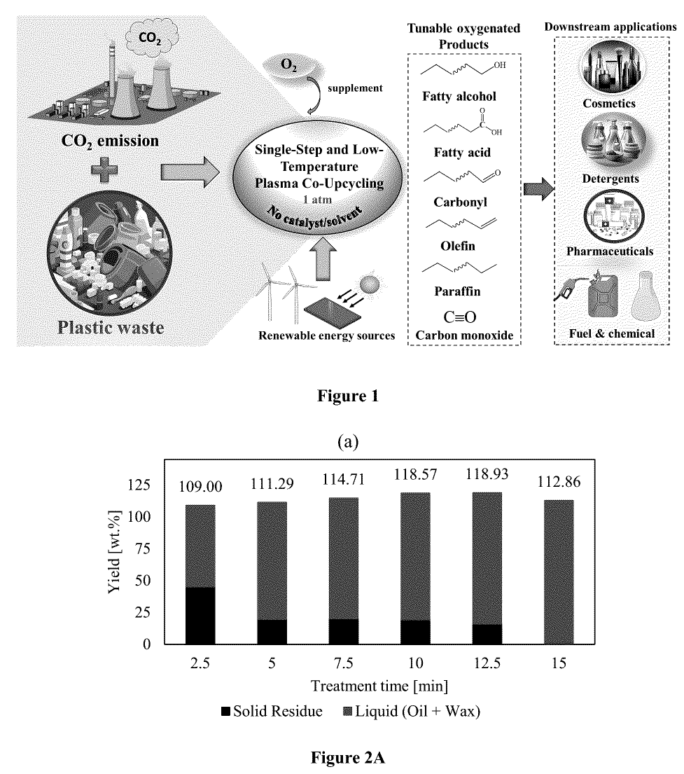

### DETAILED DESCRIPTION

One aspect of the present application relates to a method of decomposing a polymeric reactant. This method comprises reacting the polymeric reactant in an oxygen containing ionized gas plasma to decompose the polymeric reactant and produce oxygen-functionalized products. The reacting is carried out at a temperature of 20 to 450° C.

The polymeric reactant can be decomposed with or without preheating. Based on reactor configuration, preheating can be accomplished by any suitable means, including but not limited to, heating the polymeric reactant in a container (e.g., reactor) using any suitable external heat source to a sufficient temperature to melt the polymeric reactants. The container may be equipped with an agitator or stirring device. The polymer can be preheated until it melts and is then fed into the plasma reactor using an extruder, an auger, or gravity flow under pressurized or non-pressurized conditions. Additionally, the feed gas can also be preheated prior to entering plasma reactors to achieve dielectric breakdown under milder conditions inside the plasma reactor.

Plasma, which is often referred to as the fourth state of matter, are ionized gases having at least one electron that is not bound to an atom or molecule. In recent years, plasmas have become of significant interest to researchers in fields such as organic and polymer chemistry, fuel conversion, hydrogen production, environmental chemistry, biology, and medicine, among others. This interest, in part, is because plasmas offer several advantages over traditional chemical processes. For example, plasmas can generate much higher temperatures and energy densities than conventional chemical technologies; plasmas are able to produce very high concentrations of energetic and chemically active species; and plasma systems can operate far from thermodynamic equilibrium, providing extremely high concentrations of chemically active species while having a bulk temperature as low as room temperature. Many details concerning the generation and applications of plasmas are described in ALEXANDER FRIDMAN, PLASMA CHEMISTRY (Cambridge University Press, 2012), which is hereby incorporated by reference in its entirety.

Plasmas are generated by ionizing gases using any of the variety of ionization sources and may be characterized as either thermal or non-thermal, depending upon the ionization source and the extent of ionization. Thermal and non-thermal plasmas can also be characterized by the temperature of their components. Thermal plasmas are in a state of thermal equilibrium, which means that the temperature of the free electrons, ions, and heavy neutral atoms are approximately the same. Non-thermal plasmas, also referred to as low-temperature plasmas or cold plasmas, are far from a state of thermal equilibrium; the temperature of the free electrons is much greater than the temperature of the ions and heavy neutral atoms within the plasma. The reactive species and excited molecules and atoms are generated by energetic electrons rather than by high temperature. As used herein, “non-thermal plasma” or “low-temperature plasma” refers to plasma that is produced by a process that does not involve the use or generation of substantial heat; the temperature of the fluid used to generate the plasma (e.g., ambient air) is not substantially increased during the process of generating plasma. Non-thermal plasma (NTP) technology is also referred to as dielectric barrier discharge, dielectric barrier corona discharge, silent discharge plasma, high energy corona, electron beam plasma corona destruction, electro-catalytic oxidation, and capillary discharge.

The initial generation of free electrons may vary depending upon the ionization source. With respect to both thermal and non-thermal ionization sources, electrons may be generated at the surface of the cathode due to a potential applied across the electrode. In addition, thermal plasma ionization sources may also generate electrons at the surface of a cathode as a result of the high temperature of the cathode (thermionic emissions) or high electric fields near the surface of the cathode (field emissions). The energy from these free electrons may be transferred to additional plasma components, providing energy for additional ionization, excitation, dissociation, etc. For non-thermal plasmas, the ionization process typically occurs by direct ionization through electron impact. Direct ionization occurs when an electron of high energy interacts with a valence electron of a neutral atom or molecule. If the energy of the electron is greater than the ionization potential of the valence electron, the valence electron escapes the electron cloud of the atom or molecule and becomes a free electron.

Although thermal plasmas are capable of delivering extremely high powers, they have several drawbacks. For example, thermal plasmas do not allow for adjusting the amount of ionization, they operate at extremely high temperatures requiring high input energy, they lack efficiency, and may have electrode erosion problems. Non-thermal plasma ionization sources have alleviated some of these problems. Exemplary ionization sources for non-thermal plasmas include glow discharges, floating electrode dielectric barrier discharges (FE DBD), and gilding arc discharges among others. In contrast to thermal plasmas, non-thermal plasmas provide for high selectivity, high energy efficiencies, and low operating temperatures. In many non-thermal plasma systems, electron temperatures are at about 10,000 K while the bulk gas temperature may be as cool as room temperature.

Dielectric barrier discharge (DBD) may be performed using an alternating current at a frequency of from about 0.5 kHz to about 500 kHz between a high voltage electrode and a ground electrode. In addition, one or more dielectric barriers are placed between the electrodes. DBDs have been employed for over a century and have been used for the generation of ozone in the purification of water, polymer treatment (to promote wettability, printability, adhesion), and for pollution control. DBDs prevent arc formation by limiting the current between the electrodes. Different plasma electricity sources and other reactor types can also be used, including DC, AC, radio frequency or nanosecond pulsed plasma, corona glow discharge plasma, microwave plasma, and controlled arc discharge plasma.

Several materials can be utilized for the dielectric barrier. These include, but are not limited to, glass, quartz, polymer layers, and ceramics. The clearance between the discharge gaps is typically between about 0.1 mm and several centimeters. The required voltage applied to the high voltage electrode varies depending upon the pressure and the clearance between discharge gaps. For a DBD at atmospheric pressure and a few millimeters between the gaps, the breakdown voltage required to generate a plasma is about 10 kV. The breakdown voltage varies depending on the fluid supplied, the gap between the electrodes, and the dielectric strength of the dielectric layer.

In one embodiment, the ionized gas plasma comprises energetic electrons, protons, ions, radicals, molecules, and/or atoms.

In one embodiment, the polymeric reactant is heated prior to reacting to a temperature sufficient to convert the polymeric reactant to a condensable vapor form, but insufficient to decompose the polymeric reactant from its polymeric state.

The heating of the polymeric reactant is carried out at a temperature of 20 to 450° C., or any temperature or range of temperatures therein. In certain embodiments, the polymeric reactant is heated to 20-50, 20-100, 20-150, 20-200, 20-250, 20-300, 20-350, 20-400, 20-450, 40-50, 40-100, 40-150, 40-200, 40-250, 40-300, 40-350, 40-400, 40-450, 60-100, 60-150, 60-200, 60-250, 60-300, 60-350, 60-400, 60-450, 80-100, 80-150, 80-200, 80-250, 80-300, 80-350, 80-400, 80-450, 100-150, 100-200, 100-250, 100-300, 100-350, 100-400, 100-450, 120-150, 120-200, 120-250, 120-300, 120-350, 120-400, 120-450, 140-150, 140-200, 140-250, 140-300, 140-350, 140-400, 140-450, 160-200, 160-250, 160-300, 160-350, 160-400, 160-450, 180-200, 180-250, 180-300, 180-350, 180-400, 180-450, 200-250, 200-300, 200-350, 200-400, 200-450, 220-250, 220-300, 220-350, 220-400, 220-450, 240-250, 240-300, 240-350, 240-400, 240-450, 260-300, 260-350, 260-400, 260-450, 280-300, 280-350, 280-400, 280-450, 300-310, 300-320, 300-330, 300-340, 300-350, 300-360, 300-370, 300-380, 300-390, 300-400, 300-410, 300-420, 300-430, 300-440, 300-450, 310-320, 310-330, 310-340, 310-350, 310-360, 310-370, 310-380, 310-390, 310-400, 310-410, 310-420, 310-430, 310-440, 310-450, 320-330, 320-340, 320-350, 320-360, 320-370, 320-380, 320-390, 320-400, 320-410, 320-420, 320-430, 320-440, 320-450, 330-340, 330-350, 330-360, 330-370, 330-380, 330-390, 330-400, 330-410, 330-420, 330-430, 330-440, 330-450, 340-350, 340-360, 340-370, 340-380, 340-390, 340-400, 340-410, 340-420, 340-430, 340-440, 340-450, 350-360, 350-370, 350-380, 350-390, 350-400, 350-410, 350-420, 350-430, 350-440, 350-450, 360-370, 360-380, 360-390, 360-400, 360-410, 360-420, 360-430, 360-440, 360-450, 370-380, 370-390, 370-400, 370-410, 370-420, 370-430, 370-440, 370-450, 380-390, 380-400, 380-410, 380-420, 380-430, 380-440, 380-450, 390-400, 390-410, 390-420, 390-430, 390-440, 390-450, 400-410, 400-420, 400-430, 400-440, 400-450, 410-420, 410-430, 410-440, 410-450, 420-430, 420-440, 420-450, 430-440, 430-450, 440-450, 345-355° C.

In one embodiment, the reacting of the polymeric reactant is carried out in an electric field. In another embodiment, the reacting of the polymeric reactant can be carried out in a plasma reactor operating at a voltage of 10.0 to 20.0 kV (e.g., 10.0-10.5, 10.0-11.0, 10.0-11.5, 10.0-12.0, 10.0-12.5, 10.0-13.0, 10.0-13.5, 10.0-14.0, 10.0-14.5, 10.0-15.0, 10.0-15.5, 10.0-16.0, 10.0-16.5, 10.0-17.0, 10.0-17.5, 10.0-18.0, 10.0-18.5, 10.0-19.0, 10.0-19.5, 10.0-20.0, 10.5-11.0, 10.5-11.5, 10.5-12.0, 10.5-12.5, 10.5-13.0, 10.5-13.5, 10.5-14.0, 10.5-14.5, 10.5-15.0, 10.5-15.5, 10.5-16.0, 10.5-16.5, 10.5-17.0, 10.5-17.5, 10.5-18.0, 10.5-18.5, 10.5-19.0, 10.5-19.5, 10.5-20.0, 11.0-11.5, 11.0-12.0, 11.0-12.5, 11.0-13.0, 11.0-13.5, 11.0-14.0, 11.0-14.5, 11.0-15.0, 11.0-15.5, 11.0-16.0, 11.0-16.5, 11.0-17.0, 11.0-17.5, 11.0-18.0, 11.0-18.5, 11.0-19.0, 11.0-19.5, 11.0-20.0, 11.5-12.0, 11.5-12.5, 11.5-13.0, 11.5-13.5, 11.5-14.0, 11.5-14.5, 11.5-15.0, 11.5-15.5, 11.5-16.0, 11.5-16.5, 11.5-17.0, 11.5-17.5, 11.5-18.0, 11.5-18.5, 11.5-19.0, 11.5-19.5, 11.5-20.0, 12.0-12.5, 12.0-13.0, 12.0-13.5, 12.0-14.0, 12.0-14.5, 12.0-15.0, 12.0-15.5, 12.0-16.0, 12.0-16.5, 12.0-17.0, 12.0-17.5, 12.0-18.0, 12.0-18.5, 12.0-19.0, 12.0-19.5, 12.0-20.0, 12.5-13.0, 12.5-13.5, 12.5-14.0, 12.5-14.5, 12.5-15.0, 12.5-15.5, 12.5-16.0, 12.5-16.5, 12.5-17.0, 12.5-17.5, 12.5-18.0, 12.5-18.5, 12.5-19.0, 12.5-19.5, 12.5-20.0, 13.0-13.5, 13.0-14.0, 13.0-14.5, 13.0-15.0, 13.0-15.5, 13.0-16.0, 13.0-16.5, 13.0-17.0, 13.0-17.5, 13.0-18.0, 13.0-18.5, 13.0-19.0, 13.0-19.5, 13.0-20.0, 13.5-14.0, 13.5-14.5, 13.5-15.0, 13.5-15.5, 13.5-16.0, 13.5-16.5, 13.5-17.0, 13.5-17.5, 13.5-18.0, 13.5-18.5, 13.5-19.0, 13.5-19.5, 13.5-20.0, 14.0-14.5, 14.0-15.0, 14.0-15.5, 14.0-16.0, 14.0-16.5, 14.0-17.0, 14.0-17.5, 14.0-18.0, 14.0-18.5, 14.0-19.0, 14.0-19.5, 14.0-20.0, 14.5-15.0, 14.5-15.5, 14.5-16.0, 14.5-16.5, 14.5-17.0, 14.5-17.5, 14.5-18.0, 14.5-18.5, 14.5-19.0, 14.5-19.5, 14.5-20.0, 15.0-15.5, 15.0-16.0, 15.0-16.5, 15.0-17.0, 15.0-17.5, 15.0-18.0, 15.0-18.5, 15.0-19.0, 15.0-19.5, 15.0-20.0, 15.5-16.0, 15.5-16.5, 15.5-17.0, 15.5-17.5, 15.5-18.0, 15.5-18.5, 15.5-19.0, 15.5-19.5, 15.5-20.0, 16.0-16.5, 16.0-17.0, 16.0-17.5, 16.0-18.0, 16.0-18.5, 16.0-19.0, 16.0-19.5, 16.0-20.0, 16.5-17.0, 16.5-17.5, 16.5-18.0, 16.5-18.5, 16.5-19.0, 16.5-19.5, 16.5-20.0, 17.0-17.5, 17.0-18.5, 17.0-19.0, 17.0-19.5, 17.0-20.0, 17.5-18.0, 17.5-18.5, 17.5-19.0, 17.5-19.5, 17.5-20.0, 18.0-18.5, 18.0-19.0, 18.0-19.5, 18.0-20.0, 18.5-19.0, 18.5-19.5, 18.5-20.0, 19.0-19.5, 19.0-20.0, 19.5-20 kV). In another embodiment, the reacting of the polymeric reactant is carried out in a plasma reactor operating at a frequency of 5.0 to 10.0 kHz. (e.g., 5.0-5.5, 5.0-6.0, 5.0-6.5, 5.0-7.0, 5.0-7.5, 5.0-8.0, 5.0-8.5, 5.0-9.0, 5.0-9.5, 5.0-10.0, 5.5-6.0, 5.5-6.5, 5.5-7.0, 5.5-7.5, 5.5-8.0, 5.5-8.5, 5.5-9.0, 5.5-9.5, 5.5-10.0, 6.0-6.5, 6.0-7.0, 6.0-7.5, 6.0-8.0, 6.0-8.5, 6.0-9.0, 6.0-9.5, 6.0-10.0, 6.5-7.0, 6.5-7.5, 6.5-8.0, 6.5-8.5, 6.5-9.0, 6.5-9.5, 6.5-10.0, 7.0-7.5, 7.0-8.0, 7.0-8.5, 7.0-9.0, 7.0-9.5, 7.0-10.0, 7.5-8.0, 7.5-8.5, 7.5-9.0, 7.5-9.5, 7.5-10.0, 8.0-8.5, 8.0-9.0, 8.0-9.5, 8.0-10.0, 8.5-9.0, 8.5-10.0, 9.0-9.5, 9.0-10.0, 9.5-10.0 kHz). In yet another embodiment, the reacting of the polymeric reactant is carried out for 2 to 60 minutes (e.g., 2-5, 2-10, 2-15, 2-20, 2-25, 2-30, 2-35, 2-40, 2-45, 2-50, 2-55, 2-60, 3-5, 3-10, 3-15, 3-20, 3-25, 3-30, 3-35, 3-40, 3-45, 3-50, 3-55, 3-60, 4-5, 4-10, 4-15, 4-20, 4-25, 4-30, 4-35, 4-40, 4-45, 4-50, 4-55, 4-60, 5-10, 5-15, 5-20, 5-25, 5-30, 5-35, 5-40, 5-45, 5-50, 5-55, 5-60, 6-10, 6-15, 6-20, 6-25, 6-30, 6-35, 6-40, 6-45, 6-50, 6-55, 6-60, 7-10, 7-15, 7-20, 7-25, 7-30, 7-35, 7-40, 7-45, 7-50, 7-55, 7-60, 8-10, 8-15, 8-20, 8-25, 8-30, 8-35, 8-40, 8-45, 8-50, 8-55, 8-60, 9-10, 9-15, 9-20, 9-25, 9-30, 9-35, 9-40, 9-45, 9-50, 9-55, 9-60, 10-15, 10-20, 10-25, 10-30, 10-35, 10-40, 10-45, 10-50, 10-55, 10-60, 11-15, 11-20, 11-25, 11-30, 11-35, 11-40, 11-45, 11-50, 11-55, 11-60, 12-15, 12-20, 12-25, 12-30, 12-35, 12-40, 12-45, 12-50, 12-55, 12-60, 13-20, 13-25, 13-30, 13-35, 13-40, 13-45, 13-50, 13-55, 13-60, 14-15, 14-20, 14-25, 14-30, 14-35, 14-40, 14-45, 14-50, 14-55, 14-60, 15-20, 15-25, 15-30, 15-35, 15-40, 15-45, 15-50, 15-55, 15-60, 16-20, 16-25, 16-30, 16-35, 16-40, 16-45, 16-50, 16-55, 16-60, 17-20, 17-25, 17-30, 17-35, 17-40, 17-45, 17-50, 17-55, 17-60, 18-20, 18-25, 18-30, 18-35, 18-40, 18-45, 18-50, 18-55, 18-60, 19-20, 19-25, 19-30, 19-35, 19-40, 19-45, 19-50, 19-55, 19-60, 20-25, 20-30, 20-35, 20-40, 20-45, 20-50, 20-55, 20-60, 25-30, 25-35, 25-40, 25-45, 25-50, 25-55, 25-60, 30-35, 30-40, 30-45, 30-50, 30-55, 30-60, 35-40, 35-45, 35-50, 35-55, 35-60, 40-45, 40-50, 30-55, 40-60, 45-35, 45-50, 45-55, 45-60, 50-55, 50-60, 55-60 minutes).

In one embodiment, the oxygen-functionalized products are selected from the group consisting of alcohols, carboxylic acids, esters, carbonyls other than carboxylic acids and esters, and mixtures thereof. As used herein, the term “alcohol” includes both mono-alcohols and di-alcohols. In another embodiment, the oxygen-functionalized products are in liquid and/or wax form.

The heating step is optional; it can take place during all of the method, some of the method, or none of the method. In one embodiment, the heating is terminated once the reacting is initiated. In another embodiment, the heating continues during the reacting.

In one embodiment, the oxygen containing ionized gas plasma is air. For example, air can be compressed air from a tank source. In a further embodiment, the oxygen containing ionized gas plasma comprises oxygen. In another embodiment, the oxygen containing ionized gas plasma comprises carbon dioxide. In another embodiment, the oxygen containing ionized gas plasma comprises carbon dioxide and oxygen. In yet another embodiment, the oxygen containing ionized gas plasma comprises carbon monoxide.

The present application relates to decomposition of a polymeric reactant. Decomposition, or deconstruction, of a polymeric reactant refers to depolymerizing the polymeric reactant by breaking the covalent carbon-carbon bonds in the polymer to produce smaller parts, including monomers.

Polymeric reactants refer to synthetic or natural polymers capable of decomposition according to the methods described herein. A polymer refers to a chemical compound or mixture of compounds whose structure is constituted of multiple repeating units (i.e. monomers) linked by covalent chemical bonds. Within the context of the present application, the term polymer includes natural or synthetic polymers, comprising a single type of repeating unit (i.e., homopolymers) or different types of repeating units (i.e., block copolymers and random copolymers). In certain embodiments, the present application relates to decomposition of natural polymeric reactants. Natural polymers include lignin, polysaccharides, such as cellulose, hemi-cellulose, starch, and polyhydroxyalkanoates and derivatives thereof In certain embodiments, the present application relates to decomposition of synthetic polymeric reactants. As an example, synthetic polymers include polymers derived from petroleum oil, such as polyolefins, polystyrenes, aliphatic or aromatic polyesters, polyamides, polyurethanes and polyvinyl chloride.

In one embodiment, the polymeric reactant is a polyolefin. In another embodiment, the polyolefin can be selected from the group consisting of polyethylene, polypropylene, polybutylene, polystyrene, and mixtures thereof.

The polymeric reactant of the present application may be part of a polymeric waste material or portions thereof. The polymeric waste material may include at least 60%, 65%, 70%, 75%, 80%, 81%, 82%, 83%, 84%, 85%, 90%, 91%, 92%, 93%, 94%, 95%, 96%, 97%, 98%, 99%, or 100% of a polymeric reactant (or mixture thereof) as described herein. Polymeric waste material can be a heterogeneous mixture of a wide range of plastics. These materials can be obtained from industrial, commercial and residential garbage by initially removing the bulk of non-plastic contaminants such as dirt, spoiled food, paper, cloth and metals.

In one embodiment, the plasma-based conversion can be performed with a catalyst. Catalysts can be added to improve energy efficiency, control product selectivity, and increase conversion efficiency. Broad types of solid catalysts can be used, including but not limited to, zeolite catalysts, metal catalysts, metal oxides, and bi-functional catalysts.

Another aspect of the present application relates to a method of removing carbon dioxide and/or carbon monoxide from a gas mixture. This method comprises providing a gas mixture comprising carbon dioxide and/or carbon monoxide and/or oxygen and contacting the gas mixture with a polymeric reactant in an ionized gas plasma to remove carbon dioxide and/or carbon monoxide from the gas mixture and produce oxygen-functionalized products.

This aspect of the present application can be carried out using substantially the same procedures, materials, and equipment described above.

As will be understood, for any and all purposes, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and so on. As a non-limiting example, each range discussed herein can be readily broken down into a lower third, middle third and upper third, and so on. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

The term “and/or” as used herein means that the listed items are present, or used, individually or in combination. In effect, this term means that “at least one of” or “one or more” of the listed items is used or present.

Preferences and options for a given aspect, feature, embodiment, or parameter, unless the context indicates otherwise, should be regarded as having been disclosed in combination with any and all preferences and options for all other aspects, features, embodiments, and parameters described in this application.

The above disclosure is general. A more specific description is provided below in the following examples. The examples are described solely for the purpose of illustration and are not intended to limit the scope of the present application. Changes in the form and substitution of equivalents are contemplated as circumstances suggest or render expedient. Although specific terms have been employed herein, such terms are intended in a descriptive sense and not for the purposes of limitation.

### EXAMPLES

The following Examples are presented to illustrate various aspects of the present application, but are not intended to limit the scope of the claimed application.

### Example 1—CO₂, Air, and Argon as Plasma Gas

Materials and Methods

Virgin high-density polyethylene (PE) was purchased from Yangli Tech Company (China) in powder form. All HPLC-grade solvents were purchased from Fisher Scientific. High-purity GC carrier gases were purchased from Airgas, and standard gases and gas mixtures were purchased from Praxair. The standard chemicals of alkanes (C₆-C₄₀), alkenes (C₅-C₂₃), dienes (C₆-C₁₄), alcohols (C₆-C₃₀), carboxylic acids (C₆-C₂₄) and carbonyl (C₆-C₁₈) compounds used for the GCMS calibration were purchased from Fischer Scientific, Thermo Scientific, TCI America, and Sigma Aldrich.

A tubular dielectric barrier discharge (DBD) reactor was made of quartz. A tungsten rod at the center of the reactor is used as a high electric electrode. The outer surface of the reactor was covered by a copper sheet, which acts as a grounded electrode. The reactor and electrodes were inserted into another quartz tube with a larger diameter. A coil heater and insulation material were wrapped around the external quartz tube. The high-voltage electrode was connected to an AC power supply (Suman Company, CTP-2000K) to actuate plasma. Electric voltage and current were also measured using a high voltage probe (i.e., P6015A from Tektronix) and a high response current probe (Pearson Electronics, Inc., Pearson 2877). The electric current—voltage waveform was monitored using an oscilloscope (RIGOL DS1074Z). About 150 mg of HDPE was placed inside the reactor. Prior to applying plasma, the reactor was heated externally using the heater to melt plastics. Once the reactor temperature reached a preset temperature, the heater was turned off and plasma power source was turned on to initiate plasma. The ambient temperature gas was supplied to the reactor. The outlet of the plasma reactor was connected to a condenser cooled by dry ice to quench vapor products. The non-condensable gases were collected by a gas bag. After conversion, the solids remaining inside the reactor and the products collected in the condenser were weighed. Their yields were reported per initial mass of PE. The reaction time is accounted from the moment the plasma was turned on.

The liquid products were analyzed using GC/MS-FID. Agilent 7890B gas chromatograph (GC) equipped with Agilent 5977A mass spectrometer (MS) and a flame ionization detector (FID) was used to analyze liquid products. Two ZB-1701 capillary columns (60 m×0.250 mm×0.250 μm) were used in the GC. Initially, the GC oven temperature was held at 40° C. for 3 minutes and then heated to 280° C. at 4° C. min⁻¹. Finally, the oven was held at 280° C. for additional 4 minutes. The GC inlet temperature was maintained at 280° C. The flow rate of helium gas was 1 mL min−1, and the split ratio at the GC inlet was 20:1. The temperature of the FID detector was 280° C., and hydrogen and airflow rates were 5 mL min⁻¹. The standard chemicals of alkanes (C₆-C₄₀), alkenes (C₅-C₂₃), dienes (C₆-C₁₄), alcohols (C₆-C₃₀), carboxylic acids (C₆-C₂₄) and carbonyl (C₆-C₁₈) compounds used for the GCMS calibration were purchased from Fischer Scientific, Thermo Scientific, TCI America, and Sigma Aldrich.

Elemental analysis was performed using a CHNS Elemental Analyzer (Vario Micro Cube). Carbon, hydrogen, and nitrogen contents in the sample were measured, and oxygen content was calculated by mass difference.

Results and Discussion

Comparison of CO₂ , Air, and Argon as Plasma Gas

During the initial thermal heating of the reactor prior to applying plasma, plastics only melted because the reactor temperature was insufficient to decompose PE. After plasma was initiated, PE decomposition and the evolution of volatiles were observed.

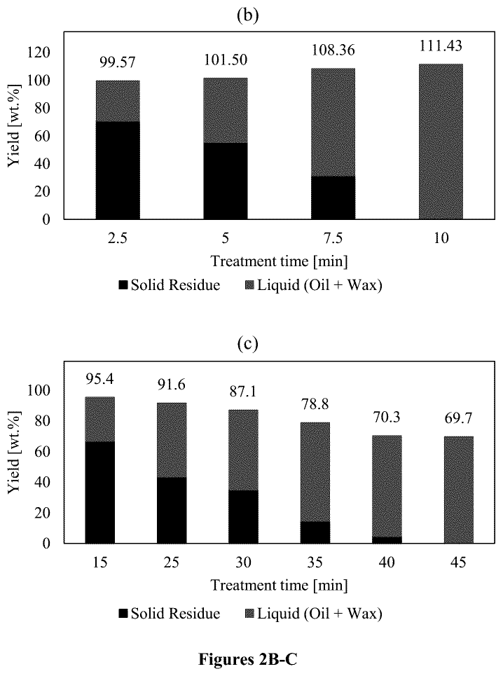

FIG. 2 shows the yields of solid residue and liquid product (condensable vapors, including oils and waxes) as a function of reaction time obtained by using CO₂, air or argon as the plasma gas. Under similar plasma conditions, the sum yields of liquid and solid exceeded 100% (per the initial mass of PE) for using air or CO₂ as the plasma gas, indicating the plasma species of these gases served as reactants. With air plasma, PE completely converted after 15 min to yield a maximum yield of 112.9%. In comparison, a complete conversion of PE and 111.4% liquid were achieved after 10 min by employing CO₂ plasma. Furthermore, complete conversion under non-reactive argon plasma yielded 69.7% liquid after 45 min.

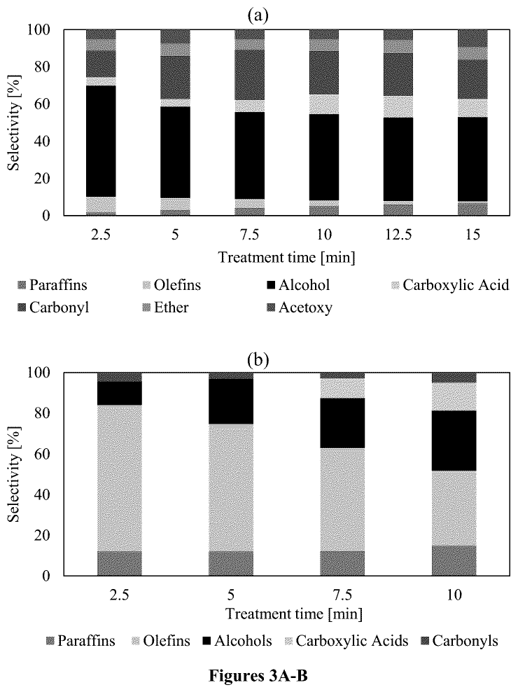

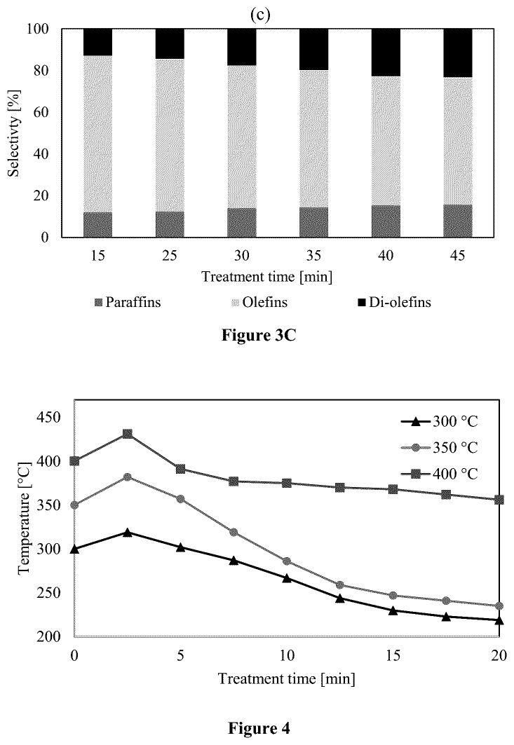

The product group mass selectivity based on GC/MS (FIG. 3) shows the liquid produced using air plasma is more oxidized than the liquid obtained using CO₂ plasma. With air plasma, various oxygenated hydrocarbons, including alcohols, carbonyls, carboxylic acids, ethers and acetoxys were produced. Olefins and paraffins were only observed in negligible amounts. In comparison, olefins and paraffins also presented in the liquids collected using CO₂ plasma in addition to oxygenated products. However, the oxygenated products were mainly carboxylic acids, alcohols, and carbonyl. Acetoxy was not observed, and ether products were negligible. With air plasma, alcohols had the highest selectivity followed by carbonyls and carboxylic acids. Only hydrocarbons were produced under argon plasma with olefins being the major product followed by di-olefins and paraffins. The product selectivity of the liquids is different because the compositions of plasma species are different when plasma discharge occurred in the air, CO₂ or argon plasma. When plasma discharge occurs in the air, electron impact causes hydrocarbon bond cleavages, and reactive oxygen species (radical, ion and atom) can further functionalize the hydrocarbon chain fragments. Where CO₂ is the input gas, other than electrons, radicals, ions, atoms and/or molecules of CO₂, CO, O, O₂ and C are produced. Thus, CO₂ originated carbon and oxygen can both be incorporated into the conversion products of PE. The hydrocarbons and oxygenated hydrocarbons derived from PE and CO₂ can be used for various applications. For example, the oxygenated hydrocarbons with reduced molecular weights can be biologically processed for useful products. With CO₂ plasma, non-condensable gases including CO (major), CH₄ (major), H₂, C₂H₂, C₂H₄, C₂H₆, C₃H₆, C₃H₈, C₄H₈, C₄H₁₀, C₅H₁₂, and O₂, were also produced, which could also be utilized for fuels and chemicals. With argon plasma, the electron impact causes bond-cleavage in the hydrocarbon backbone of the PE, producing aliphatic hydrocarbons in both gas and liquid products. The results show that the conversion of PE using CO₂ plasma has an extra benefit as this method can use the plastics as the chemical sink of CO₂ to produce attractive chemicals.

Effect of Initial Reactor Temperature

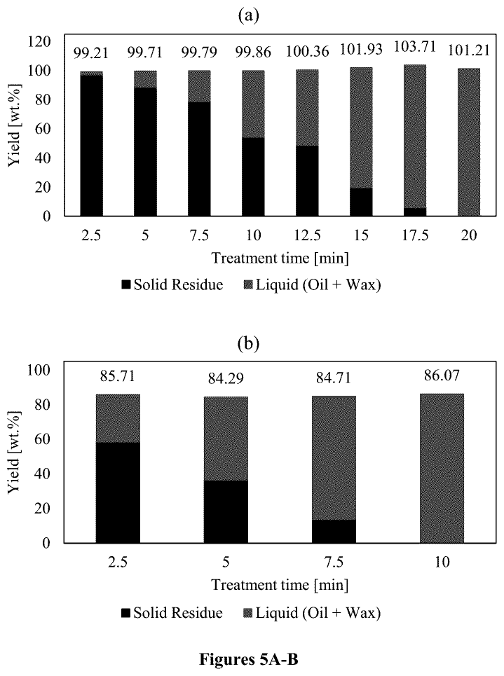

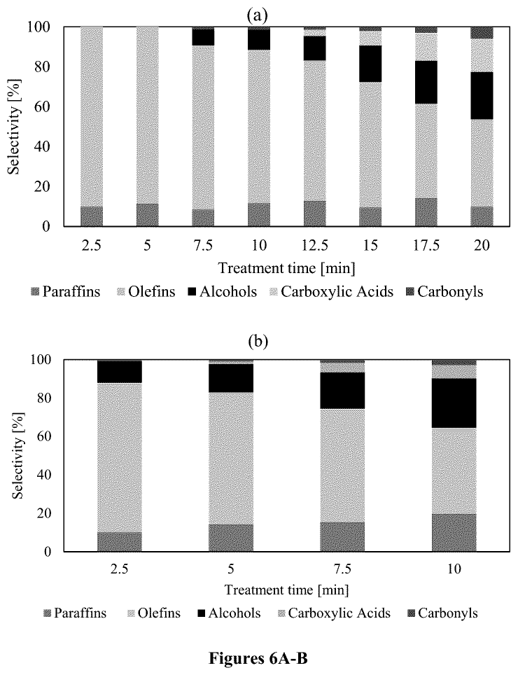

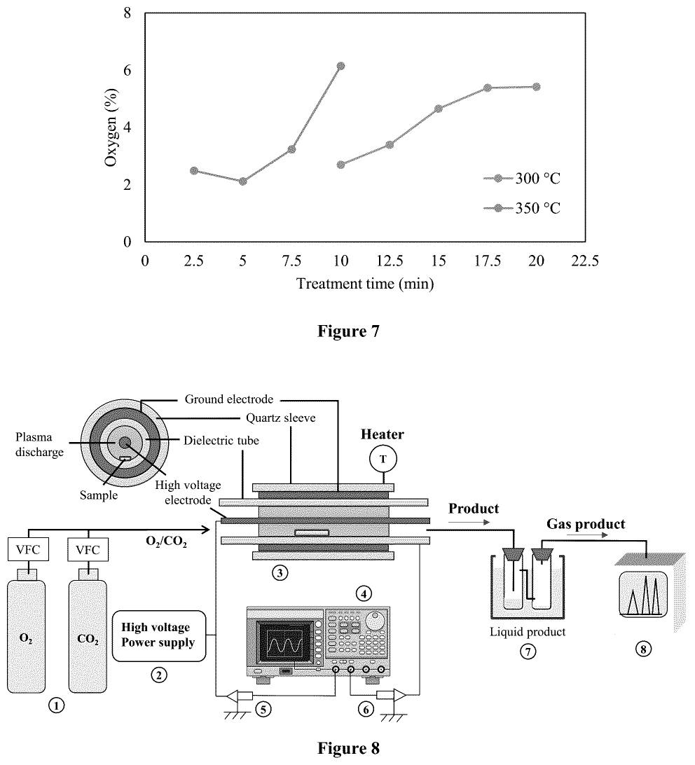

In this work, the reactor was thermally heated prior to plasma initiation although thermal heating was terminated once the plasma was initiated. While preheating the reactor is not always necessary depending on the plasma power source and incoming gas temperature, there are several benefits for preheating the reactor in this work. Higher initial reactor temperature can lower the voltage requirement for dielectric breakdown and increase the plasma intensity. Preheating can also melt plastics and more uniform plasma could be applied to molten plastics. Thus, the effect of initial reactor temperature was studied by comparing an initial reactor temperature of 300, 350, and 400° C. using CO₂ plasma. The dependency of the reactor temperature profile on the initial reactor temperature was straightforward. When the initial reactor temperature was 300° C., the reactor temperature throughout the reaction was lower than the higher temperature cases (FIG. 4). As given in FIG. 5, increasing the initial reactor temperature enhanced PE conversion. With the initial temperature of 300° C., it took 20 min to completely convert PE whereas it only took 10 min for the higher initial temperatures. On the other hand, the maximum liquid yield for the case of 300° C. was 101.2%, lower than 111.4% for the case of 350° C., but much higher than 86.8% for the case of 400° C. Excessively high initial reactor temperature led to a strong plasma discharge, which caused excessive cracking of PE to gases rather than liquid products. On the other hand, the selectivity of total oxygenated compounds and that of alcohols was highest with the reactor temperature of 350° C. (FIG. 2B, FIG. 5). The selectivity of alcohols could increase from 23% for 300° C. to 26% for the case of 400° C., at the expense of decreased carboxylic acids (FIG. 6). Compared to the case of 350° C., maximum oxygen content in the liquid was lower in the case of 300° C. (FIG. 7).

### Example 2—CO₂ and CO₂/O₂ as Plasma Gas

Materials and Methods

Virgin high-density polyethylene (PE) was purchased from Yangli Tech Company (China), while post-consumer (PC-PE) was collected from material recovery facilities with further processing by cryo-milling and ultrasonic washing before use. All HPLC-grade solvents (dichloromethane, toluene, pyridine, and tetrahydrofuran) were purchased from Fisher Scientific. High-purity GC carrier gases were purchased from Airgas. The silylation agent (N, O-Bis(trimethylsilyl)trifluoroacetamide with trimethylchlorosilane) for identification of carboxylic acid and alcohols compounds, and NMR relaxation agent (Chromium (III) acetylacetonate) were supplied by Sigma Aldrich. High-purity standard gases (CO, CO₂, H₂, O₂) and light hydrocarbon gases were purchased from Praxair. Isotopic ¹³CO₂ was supplied by Cambridge Isotopes Laboratories, Inc. The standard chemicals of alkanes (C₆-C₄₀), alkenes (C₅-C₂₃), dienes (C₆-C₁₄), alcohols (C₆-C₃₀), carboxylic acids (C₆-C₂₄) and carbonyl (C₆-C₁₈) compounds used for the GCMS calibration were purchased from Fischer Scientific, Thermo Scientific, TCI America, and Sigma Aldrich.

Plasma-Based Conversion Experiment

FIG. 8 shows a schematic diagram of the plasma reactor and product recovery system. The experiments were conducted in co-axial dielectric barrier discharge (DBD) reactors made of quartz tubes with internal and external diameters of 10.5 mm and 12.7 mm with two different tube lengths. A tungsten rod of 1.6 mm external diameter was inserted as a high-voltage electrode. The outer surface of the reactor was covered by a copper sheet, which acted as a grounded electrode. The high-voltage electrode was connected to a high-voltage AC power supply (Nanjing Suman Company, CTP-2000 K), with a maximum peak-to-peak sinusoidal voltage of 30 kV and a center frequency of 10 kHz. Electric voltage and current were measured using a high-voltage probe (i.e., P6015A from Tektronix) and a high-response current probe (Pearson Electronics, Inc., Pearson 2877), equipped with an oscilloscope (Tektronix MDO3102 mixed domain). Inside the plasma reactors, the length of the plasma discharge zone was either 5 or 10 inches depending on the reactor tube length. About 0.15 g of plastics were evenly placed in the middle section of the plasma reactor with a shorter tube length, with the initial sample length along the axial direction being 1 inch. When 1 g of plastics (a 7×mass case) were converted using the reactor with a longer tube length, the initial sample length in the middle of the tube was 2.5 inches. Reaction gases entered the reactor at the inlet. The volume flow rates were controlled by volumetric flowmeters, calibrated prior to the experiments by a high-accuracy universal flow controller (Agilent, model ADM G6691) with an accuracy of ±0.2 mL/min. The gas flow rate was between 32.5 and 65 mL/min for the reactor with a shorter tube length and between 65 and 100 mL/min for the reactor with a longer tube length. The reactor tube and electrodes were inserted into another quartz tube with a larger diameter, while a coil heater and high-temperature insulation material were wrapped around the external quartz tube. This quartz sleeve isolated the heater from the plasma discharge.

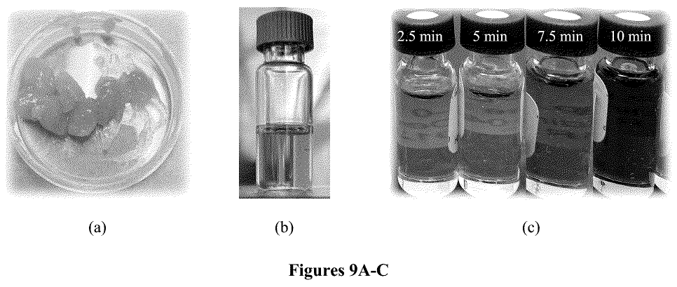

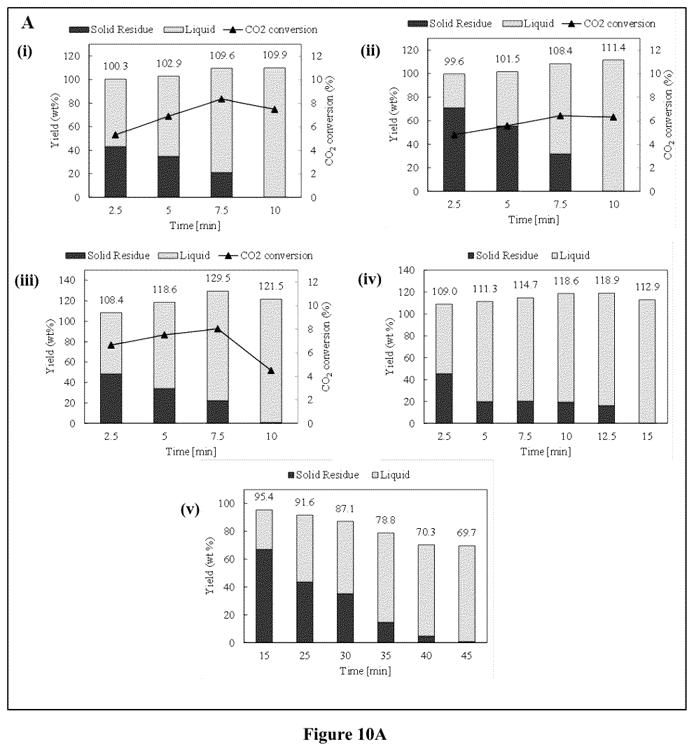

Initially, the reactor was briefly heated externally by a heater for about 4 min until the internal reactor gas temperature reached 350° C. so that the plastics were melted onto the reactor wall. After the temperature reached the set temperature, the heater was turned off, followed by turning on the plasma generator so that plasma became the sole energy source. The reaction was carried out under atmospheric pressure, and reaction time was calculated from the moment the plasma generator was turned on. The gas temperature inside the reactor was measured by quickly inserting a thermocouple into the reactor via the gas inlet at each time point to collect temperature data. The system was kept insulated during the entire conversion. The vapors and gases leaving the reactor at the other end were passed through a two-stage condenser cooled with methanol—dry ice mixtures to collect liquids before non-condensable gases entered a micro-GC for gas analysis. The reactor outlet gas flow was continuously measured downstream of the condenser using the high-accuracy universal gas flowmeter during the reaction. The current and voltage were monitored during the reaction using an oscilloscope to determine plasma power. The reactor, condenser, and connector were weighed before and after the conversion using an analytical balance with an accuracy of 0.0001 g (Veritas, M124AS) to determine the masses of the liquids and solid residues. For liquid analysis, the liquid products (see FIG. 9) were collected by washing the condenser tube and connector using a toluene and pyridine solvent mixture (2.5/1.5 v/v).

For converting a model compound using isotopic ¹³CO₂ plasma, the experiment was carried out using a sealable DBD plasma reactor. The reactor had similar dimensions to the above-mentioned plasma reactor, except it had inlet and exit valves. In the beginning, about 0.15 g of Eicosane (C₂₀H₄₂) was placed in the reactor and purged with regular CO₂ to remove residual air. The compound was then melted at 60° C. and cooled down. The inlet valve of the reactor was closed after CO₂ purging, and the exit valve was connected to a vacuum source to remove the purging gas. Subsequently, the exit value was closed, and the inlet valve was opened to fill the reactor with ¹³CO₂ gas. Subsequently, both valves were closed, and the plasma power source was turned on. After conversion, the products inside the reactor were collected by a toluene and pyridine solvent mixture (2.5/1.5 v/v). Eicosane was also converted using regular CO₂ as plasma gas to collect products, aiding product identification during the isotopic tests.

Characterization Methods

High-Temperature Gas Chromatography with Mass Spectrometry and Flame Ionization Detector (HT-GC/MS-FID)

The liquid products were analyzed using HT-GC/MS-FID. Before analysis, the samples in a dissolving solvent were derivatized by adding 200 μL of the BSTFA silylation agent to 3 mL of the solution and agitated for 60 min at 60° C. In this GC system (Agilent 7890Bs) with MS (MS 5977A, Agilent, USA) and FID, two high-temperature columns (400° C., Phenomenex ZB-5HTs, 60 m×250 μm×0.25 μm) were used. The GC oven temperature was initially kept at 40° C. for 3 min, increased to 400° C. with a heating rate of 3° C./min, and held at 400° C. for another 5 min. The GC/MS was also configured with a Polyarc reactor (Polyarc System, Activated Research Technologies, Inc., USA) in the front of the FID to provide a carbon mass-based response for the detected analytes irrespective of their functional group or boiling point. The helium gas flow rate in the columns was 1 mL/min, and the split ratio at the GC inlet was 20:1. The temperature of the FID detector was set at 375° C. Agilent MassHunter software was used to process the GC chromatograms and measure peak areas. The compounds in the liquid products were identified using a combination of tools, including the NIST MS spectral and mass ion database. High-purity standards of alkane, alkene, alcohol, diol, carboxylic acid, and aldehyde were injected into the GC to aid MS identification. Five different concentrations of the alkane standards were injected to calibrate the Polyarc-FID for liquid product quantification. Since the Polyarc-FID calibration is based on carbon response, the calibration factor from a particular carbon number of alkane can be used for any compound containing the same number of carbons. The resultant calibration curves had regression coefficients higher than 0.99.

In all liquid samples, individual products up to C₂₈ carbon number could be quantified due to their good peak separations in the MS chromatograms. At >C₂₈ compound region, co-elution of different class compound peaks was noticed in some liquid samples for higher molecular weight products. In this case, the mass yield of >C₂₈ compounds was determined by the mass difference of total gravimetric liquid yield and the sum of GC-quantified compound yields (up to C₂₈). In these limited cases, the functional group selectivity of compounds up to C₂₈ was considered for the entire liquid product.

Gas Analysis

The gas products were analyzed online using the Varian CP4900 micro-GC system (Varian, Inc., now owned by Agilent Technologies). In the GC oven, four different columns were connected to four different thermal conductivity detectors (TCD). The first TCD quantifying H₂, CH₄, CO, and O₂ used argon as a carrier gas, while the rest TCDs quantifying CO₂ and other light hydrocarbons used helium as a carrier gas. Gas calibration was performed by injecting different volumes of the standard gas mixtures. Compass CDS software (Scion Instruments, UK) was used to operate, calibrate, and quantify the gaseous compounds. The gas product concentrations (v/v) were calculated using the calibration curves and the peak areas of the corresponding compound in TCD. The outlet flow rate of the reactor during the plasma conversion was used to measure the total gas product volume, which was then used to calculate the total mass of the inlet gas.

Elemental Analysis

Elemental analyses of the plastic feedstock and liquid products were performed using standard procedure in Elementar, vario MICRO cube (Elementar, Hanau, Germany) elemental analyzer and were triplicated. The element contents of C, H, N, and S were measured, while the oxygen content was calculated by subtracting C, H, N, and S contents from the total content.

Karl Fischer Analysis

Water content in liquid products was measured using a Volumetric Karl Fischer titrator (Mettler Toledo, model V30S) following the ASTM E203 Standard. About 0.04-0.06 g of samples were dissolved in 1 mL of Hydranal solvent (dry methanol), and the averages of triplicate measurements were reported.

Nuclear Magnetic Resonance (NMR)

¹³C Nuclear magnetic resonance (NMR) experiments for liquid samples were performed by Avance NEO-400 spectrometer. The NMR samples were prepared by adding 0.2 g of samples in 1 mL of chloroform-D solvent and a relaxation agent, 3M chromium (III) acetylacetonate, to improve the intensity of weak signals (Wang et al., “Development of Quantitative ¹³C NMR Characterization and Simulation of C, H, and O Content for Pyrolysis Oils Based on ¹³C NMR Analysis,” RSC Advances 10: 25918-25928 (2020), which is hereby incorporated by reference in its entirety). The sample mixtures were ultrasonicated for an hour before analysis. The ¹³C NMR spectra were acquired using pulse sequence “zgig” at 25° C. with a relaxation delay of 2 seconds and 7200 scans over a total acquisition time of around 7 hours. Spectral widths f1 and f2 were 220 ppm and 12 ppm, with centers at 90 ppm and 5 ppm, respectively. The NEO-400 is operated using Topspin 4.0 software, and the NMR spectra were processed using MestReNova v14.3 software. The NMR peaks were assigned based on literature (Wang et al., “Development of Quantitative ¹³C NMR Characterization and Simulation of C, H, and O Content for Pyrolysis Oils Based on ¹³C NMR Analysis,” RSC Advances 10: 25918-25928 (2020); Partington et al., “Quantitative Carbon Distribution Analysis of Hydrocarbons, Alcohols and Carboxylic Acids in a Fischer-Tropsch Product from a CO/TiO2 Catalyst During Gas Phase Pilot Plant Operation,” Journal of Analytical Science and Technology 11: 42 (2020); Speight et al., “1H and 13C Solution- and Solid-State NMR Investigation into Wax Products from the Fischer-Tropsch Process,” Solid State Nuclear Magnetic Resonance 39: 58-64 (2011); which are hereby incorporated by reference in their entirety). The selectivity of functional groups was calculated using the following equations adapted from the methods specified in literature (Partington et al., “Quantitative Carbon Distribution Analysis of Hydrocarbons, Alcohols and Carboxylic Acids in a Fischer-Tropsch Product from a CO/TiO2 Catalyst During Gas Phase Pilot Plant Operation,” Journal of Analytical Science and Technology 11: 42 (2020); Speight et al., “1H and 13C Solution- and Solid-State NMR Investigation into Wax Products from the Fischer-Tropsch Process,” Solid State Nuclear Magnetic Resonance 39: 58-64 (2011); which are hereby incorporated by reference in their entirety). The peak areas of the carbons linked to the different functional groups in the liquid product are denoted by [A], [B], [C], [D], and [E] where
[A]=peak area of R—CH₂—OH (assigned 60-95 ppm),
[B]=peak area of R—COOH (assigned 175-180 ppm),
[C]=peak area of R—COH, R—CO—R′ and R—COO—R′ (assigned 180-210 ppm),
[D]=average of peak areas of R—CH═CH₂ (assigned 135-140 ppm) and R—CH═CH₂ (assigned 110-115 ppm), and
[E]=peak area of R—CH₃ (assigned 10-20 ppm).
   The ¹³C-NMR selectivity of the different functional groups was calculated as follows:

$$Alcohols [ F ] = \frac{[ A ]}{[ A ] + [ B ] + [ C ] + [ D ] + [ E ] - ( [ A ] + [ B ] + [ C ] + [ D ] ) / 2} \times 100 \% \qquad ( S 1 )$$

$$Carboxylic acids [ G ] = \frac{[ B ]}{[ A ] + [ B ] + [ C ] + [ D ] + [ E ] - ( [ A ] + [ B ] + [ C ] + [ D ] ) / 2} \times 100 \% \qquad ( S 2 )$$

$$Other oxygenated compounds [ H ] = \frac{[ C ]}{[ A ] + [ B ] + [ C ] + [ D ] + [ E ] - ( [ A ] + [ B ] + [ C ] + [ D ] ) / 2 ]} \times 100 \% \qquad ( S 3 )$$

$$Olefins [ I ] = \frac{[ D ]}{[ A ] + [ B ] + [ C ] + [ D ] + [ E ] - ( [ A ] + [ B ] + [ C ] + [ D ] ) / 2 ]} \times 100 \% \qquad ( S 4 )$$

$$Paraffins [ J ] = \frac{[ E ] - ( [ A ] + [ B ] + [ C ] + [ D ] ) / 2}{[ A ] + [ B ] + [ C ] + [ D ] + [ E ] - ( [ A ] + [ B ] + [ C ] + [ D ] ) / 2} \times 100 \% \qquad ( S 5 )$$

$$Aliphatic hydrocarbons [ K ] = [ I ] + [ J ] \qquad ( S 6 )$$

Definitions for Product Yield, Selectivity and Energy Consumption

Liquid or solid yields based on the initial plastic mass are calculated as shown below:

$$Liquid yield ( wt \% ) = \frac{Mass of liquid product}{Plastic feedstock mass} \times 100 \% \qquad ( S7 )$$

$$Solid yield ( wt \% ) = \frac{Mass of solid residue}{Plastic feedstock mass} \times 100 \% \qquad ( S8 )$$

Time-accumulative CO₂ conversion up to the given reaction time is calculated as:

$${CO}_{2} conversion ( wt \% ) = \frac{Total input {CO}_{2} mass - Total output {CO}_{2} mass}{Total input {CO}_{2}} \times 100 \% \qquad ( S9 )$$

The mass yield of an individual gas compound per plastics are calculated as:

$$Gas coumpound yield ( wt \% ) = \frac{Mass of the gas compound}{Plastic feedstock mass} \times 100 \% \qquad ( S10 )$$

where gas compound mass is calculated using eq. (S12)

Mass of a gas compound=Mass fraction of the gas×Total mass of all gas products (S11)

The mass selectivity of individual gas compound among the total gas product was calculated as:

$$Gas compound selectivity ( \% ) = \frac{Mass of an individual gas}{Total mass of the gas product} \times 100 \% \qquad ( S12 )$$

The yield of an individual liquid compound per initial plastic mass is calculated as:

$$Liquid compound yield ( wt \% ) = \frac{Mass of a compound}{Plastic feedstock mass} \times 100 \% \qquad ( S13 )$$

The mass selectivity of a compound with a functional group in the liquid is calculated as:

$$Compound selectivity in liquid ( \% ) = \frac{Mass of the compounds with the functional group}{Total mass of the liquid product} \times 100 \% \qquad ( S14 )$$

For mass balance of the conversion system including all reactants, the calculations are given below:

$$Product yield ( wt \% ) = \frac{Mass of the product}{Combined mass of the plastic and converted CO2 ( and O2 )} \times 100 \% \qquad ( S15 )$$

External Energy Consumption in this Work

The external energy consumed during CO₂/O₂ plasma-based co-conversion is reported for converting two different PE mass loading and inlet gas flow rates using the original and scaled-up reactors. Since the plastic and inlet gases were heated briefly before applying plasma, the energy consumption included thermal energy and plasma energy. Thermal energy is the energy spent on the pre-plasma heating process, calculated by considering the sensible heats of CO₂, O₂, and PE from room temperature to 350° C., and the latent heat of PE melting. The plasma energy was measured during the conversion using the process mentioned in the methods section. In the reactor, the external energy input is used to heat the inlet gases (both converted and unconverted), heat plastics, convert the feed gases and plastics, and vaporize the products. Some energy was also lost through the reactor wall.

The total energy consumed per kg of feedstock (MJ/kg) is reported based on the following equation:

$$Energyconsumed MJ / kg = Heatingenergy MJ + Plasmaenergy MJ {MasssumofPEandconvertedCO}_{2} {andO}_{2} ( kg ) \qquad ( S16 )$$

$$Energy consumed ( MJ / kg ) = ( \frac{Heating energy ( MJ ) + Plasma energy ( MJ )}{Mass sum of PE and converted CO2 and O2 ( kg )}$$

External Energy Consumption for Thermal Liquefaction Plants

The energy consumptions for the Niigata, Mikasa and Sapporo thermal liquefaction plants from Japan discussed above were calculated based on the energy balance provided in the reference (J. Scheirs and W. Kaminsky, Feedstock Recycling and Pyrolysis of Waste Plastics, J. Wiley & Sons (2006), which is hereby incorporated by reference in its entirety). Based on the plant in question, the process energy was from hybrid sources, either generated by burning a part of the pyrolysis oils and other fuels such as liquefied petroleum gas (LPG) and fuel gas or directly through electricity. The lower heating values of 47.1, 45.5 and 42.8 MJ/kg were used for calculating the process energy derived from fuel gas, LPG, and pyrolysis oil, respectively. Unless the process energy per converted mass (MJ/kg) was specified in literature directly, this number was calculated based on the total process energy (MJ) and plastic waste feed mass.

Results and Discussion

In this work, virgin high-density PE was first converted using a co-axial tubular dielectric discharge barrier (DBD) plasma reactor operating under a continuous-flow semi-batch configuration (FIG. 8). Plastics were placed on the bottom wall of the horizontally placed reactor, and the reaction gas entered at one end. The vapor products exiting at the other end were condensed outside the reactor to obtain liquids, and non-condensable gases were analyzed online. A plasma power supply with a fixed voltage and frequency from optimized conditions (f=8 kHz and V=15 kV, the optimization tests are discussed in the Supplementary text) was used in this work. Changing the inlet gas flow rate controlled the gas residence time under the plasma discharge zone (t_{R}). Prior to the plasma actuation, the reactor was briefly heated to 350° C. by a heater to melt plastics, but the external heating was removed as soon as the plasma power supply was turned on. The measured reactor gas temperature during the plasma-based reaction changed between ˜300 and ˜400° C. in most cases (Table 1 for measured plasma power and reactor temperature), which are usually insufficient to thermally decompose PE (See “Thermal Effect on Plastic Conversion” section included later in this disclosure for a discussion of the thermal effect).

TABLE 1
Internal gas temperature in the plasma reactor and plasma power for
different reaction conditions. All conditions used 0.15 g of PE sample.

| | | | | | Plasma type | | | |
|---|---|---|---|---|---|---|---|---|
| | Gas | | | | CO₂ | | CO₂/O₂ | |
| Flow rate | residence | f | V | Time | Power | Temperature | Power | Temperature |
| (mL/min) | time, t_{R} (s)* | (kHz) | (kV) | (min) | (W) | (° C.) | (W) | (° C.) |
| 50 | 13.19 | 8 | 12.5 | 0 | 0 | 350 | — | — |
| | | | | 10 | 49 | 232 | — | — |
| | | | | 12.5 | 47 | 221 | — | — |
| | | | | 15 | 46 | 212 | — | — |
| | | | | 17.5 | 46 | 201 | — | — |
| | | | | 20 | 44 | 181 | — | — |
| 50 | 13.19 | 8 | 15 | 0 | 0 | 350 | 0 | 350 |
| | | | | 2.5 | 107 | 382 | 88 | 388 |
| | | | | 5 | 102 | 357 | 85 | 364 |
| | | | | 7.5 | 101 | 319 | 84 | 324 |
| | | | | 10 | 98 | 286 | 84 | 293 |
| 50 | 13.19 | 8 | 17.5 | 0 | 0 | 350 | — | — |
| | | | | 2.5 | 136 | 459 | — | — |
| | | | | 5 | 138 | 406 | — | — |
| | | | | 7.5 | 138 | 368 | — | — |
| 50 | 13.19 | 7.5 | 15 | 0 | 0 | 350 | — | — |
| | | | | 2.5 | 98 | 370 | — | — |
| | | | | 5 | 97 | 349 | — | — |
| | | | | 7.5 | 98 | 304 | — | — |
| | | | | 10 | 96 | 274 | — | — |
| 50 | 13.19 | 8.5 | 15 | 0 | 0 | 350 | — | — |
| | | | | 2.5 | 108 | 398 | — | — |
| | | | | 5 | 109 | 379 | — | — |
| | | | | 7.5 | 115 | 357 | — | — |
| | | | | 10 | 118 | 312 | — | — |
| 32.5 | 20.29 | 8 | 15 | 0 | 0 | 350 | 0 | 350 |
| | | | | 2.5 | 99 | 388 | 82 | 393 |
| | | | | 5 | 97 | 370 | 79 | 378 |
| | | | | 7.5 | 100 | 338 | 77 | 345 |
| | | | | 10 | 100 | 317 | | |
| 65 | 10.15 | 8 | 15 | 0 | 0 | 350 | — | — |
| | | | | 2.5 | 93 | 367 | — | — |
| | | | | 5 | 90 | 333 | — | — |
| | | | | 7.5 | 91 | 301 | — | — |
| | | | | 10 | 90 | 271 | — | — |
| | | | | 12.5 | 90 | 245 | — | — |
| | | | | 15 | 89 | 223 | — | — |

*Calculated using the inlet gas flow rate, plasma discharge zone length, and the inner diameter of the reactor.

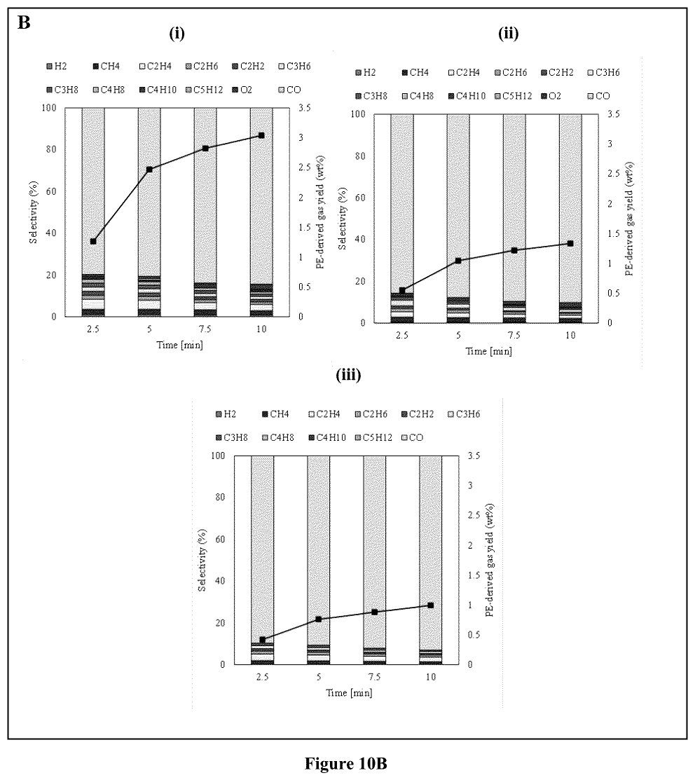

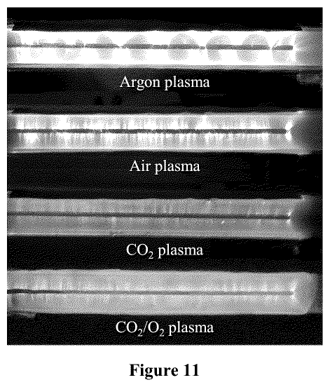

The time-dependent yields of solid residue remaining inside the reactor and liquid product collected outside of the reactor are shown in FIG. 10A for the different plasma gas compositions (i.e., CO₂, a CO₂ and 8 vol % O₂ mixture, argon, and air; the plasma discharge images in FIG. 11) and gas residence times (t_{R} of 13s or 20s, corresponding to the inlet gas flow rates of 50 mL/min or 32.5 mL/min). The reproducibility of the experiments is given in Table 2. PE conversion was completed within 10 min using a CO₂ plasma with t_{R} of 13s or 20s (Table 1), producing 111.4 wt % and 109.9 wt % of liquids, respectively (yields are reported per plastic feedstock mass unless specified otherwise). The liquid yield further increased with CO₂/O₂ plasma (t_{R}=13s), registering 120.7 wt % after a 10 min conversion. In comparison, the complete conversion of PE took 15 min with air plasma (t_{R}=13s) or 45 min with argon plasma (t_{R}=13s), producing 112.9 wt % or 69.0 wt % of liquids. These results imply that CO₂ plasma was much more effective than air or argon plasma in depolymerizing PE. Furthermore, extending the residence time under the plasma zone or supplementing CO₂ with a small amount of O₂ (8 vol % in this work, unless specified otherwise) could increase reaction rates. The liquid masses produced with the CO₂-based plasmas exceeded PE feedstock masses, indicating that the chemical insertion of CO₂ contributed to the high liquid product formation. The time-accumulative CO₂ conversion during the plasma-based conversion of PE is also plotted in FIG. 10A (i)-(iii) for the relevant cases. It shows that CO₂ conversion increased with increasing PE conversion and leveled off when PE completed conversion and the vapor products were removed from the reactor. The CO₂ conversion for completing PE conversion was 7.5% for CO₂ plasma (t_{R}=20s), compared to 6.3% for CO₂ plasma (t_{R}=13s), and 4.5% for CO₂/O₂ plasma (t_{R}=13s).

TABLE 2
Reproducibility of the experiment using PE conversion by CO₂ plasma and
t_{R} = 13 s as example. The reaction conditions: voltage 15 kV, frequency 8 kHz, CO₂
inlet flow rate of 50 mL/min, initial reactor temperature 350° C., reaction time 10 min.

| | | | | | | | | CO₂ |
|---|---|---|---|---|---|---|---|---|
| | | Reactor mass (g) | | Condenser mass (g) | | | | conversion |
| Test No | PE mass (g) | Before | After | Before | After | Liquid mass (g) | Liquid yield (%) | (%) |
| 1 | 0.1532 | 26.2991 | 26.3065 | 180.4964 | 180.6585 | 0.1695 | 110.6 | 6.25 |
| 2 | 0.1481 | 26.5579 | 26.5993 | 169.8593 | 169.9832 | 0.1653 | 111.6 | 6.30 |
| 3 | 0.1528 | 26.7436 | 26.7846 | 181.8198 | 181.95 | 0.1712 | 112.0 | 6.27 |

| | | |
|---|---|---|
| Average (%) | 111.4 | 6.27 |
| Standard error (%) | ±0.7% | ±0.03% |

In addition to the liquid products, PE conversion by CO₂ or CO₂/O₂ plasma also produced gas products consisting of CO, O₂, H₂, and light hydrocarbons (C₁-C₅ alkanes and alkenes, FIG. 10B). Carbon monoxide was the primary gas product with its time-accumulative product selectivity reaching between 84.9% and 93.0% for different reaction cases. PE-derivable hydrogen and light hydrocarbons were minor, and their total yields decreased from 3.0 wt % for the CO₂ plasma case with t_{R}=13s to 1.3 wt % under CO₂ plasma with t_{R}=20s and to 1.0 wt % for the CO₂/O₂ plasma (t_{R}=13s) case. Their low yields indicate that PE mostly converts to liquid compounds rather than gases during its co-conversion with CO₂. Oxygen molecular content in the gas stream was also minor when CO₂ plasma was used, indicating CO₂-derivable O₂ is either inhibited or mostly consumed during the reaction.

Liquid products from the PE conversion by CO₂ or CO₂/O₂ plasma manifest as oily and waxy substances at room temperature. However, they transition into flowable liquids at 80° C. and display complete solubility in a mixture of toluene and pyridine (FIG. 9). The oxygen element contents of the liquids were 6.2%, 7.8%, and 11.2%, respectively, for the CO₂ plasma (t_{R}=13s), CO₂ plasma (t_{R}=20s), and CO₂/O₂ plasma (t_{R}=13s) cases (the element analysis results in Table 3).

TABLE 3
Characterization of liquids obtained from different feedstock and
reaction conditions*

| Con- | A | B | C | D | E | F | G | H | I |
|---|---|---|---|---|---|---|---|---|---|
| dition* | wt % | wt % | wt % | wt % | wt % | wt % | wt % | wt % | wt % |
| Liquid | 111.4 | 109.9 | 120.7 | 111.1 | 105.9 | 108.8 | 106.4 | 80.6 | 110.8 |
| yield | | | | | | | | | |

Product carbon number distribution

| | | | | | | | | | |
|---|---|---|---|---|---|---|---|---|---|
| C₅-C₁₂ | 28.2 | 50.1 | 64.4 | 60.1 | 39.6 | 22.4 | 39.2 | 15.6 | 56.7 |
| C₁₃-C₂₀ | 23.4 | 24.4 | 37.1 | 32.7 | 33.3 | 21.9 | 25.2 | 13.1 | 29.2 |
| C₂₁-C₂₈ | 22.6 | 19.2 | 13.2 | 15.6 | 20.1 | 21.2 | 27.1 | 12.0 | 16.5 |
| C₂₈₊ | 37.2 | 16.3 | 6.1 | 2.6 | 12.9 | 43.3 | 15.0 | 35.2 | 8.4 |

Elemental analysis (wt %)

| | | | | | | | | | |
|---|---|---|---|---|---|---|---|---|---|
| C (%) | 80.9 | 79.6 | 76.7 | 77.0 | 82.3 | 81.2 | 80.6 | 82.8 | 76.8 |
| H (%) | 12.9 | 12.5 | 12.1 | 12.1 | 13.3 | 13.0 | 13.0 | 13.3 | 12.2 |
| O (%) | 6.2 | 7.8 | 11.2 | 10.9 | 4.8 | 5.8 | 6.3 | 3.9 | 11.0 |

*Reaction conditions
A: PE, CO₂ plasma, 50 mL/min or 13 s, 15 kV, 8 kHz, 10 min
B: PE, CO₂ plasma, 32.5 mL/min or 20 s, 15 kV, 8 kHz, 10 min
C: PE, CO₂/O₂ plasma, 50 mL/min or 13 s, 15 kV, 8 kHz, 10 min
D: PC-PE, CO₂/O₂ plasma, 50 mL/min or 13 s, 15 kV, 8 kHz, 10 min.
E: PE, CO₂ plasma, 50 mL/min or 13 s, 17.5 kV, 8 kHz, 7.5 min
F: PE, CO₂ plasma, 50 mL/min or 13 s, 15 kV, 7.5 kHz, 10 min
G: PE, CO₂ plasma, 50 mL/min or 13 s, 15 kV, 8.5 kHz, 10 min
H: PE, CO₂ plasma, 65 mL/min or 10 s, 15 kV, 8 kHz, 12.5
I: PE, CO₂/O₂ plasma, 32.5 mL/min or 20 s, 15 kV, 8 kHz, 7.5 min
In the above, the initial reactor temperature is 325° C. for the case “D” and 350° C. for the rest cases.

The water content was negligible in all three liquids (<0.7%, Table 4). These results combine to show that oxidative depolymerization of PE using CO₂ plasma was successful, where increasing t_{R} or using CO₂/O₂ plasma promotes oxygenated products.

TABLE 4
Moisture content of liquid products obtained from PE or
PC-PE conversion using CO₂ plasma or CO₂/O₂ plasma. Reaction
conditions: 15 kV, 8 kHz, 10 min, t_{R} is given.

| | PE | | | PC-PE |
|---|---|---|---|---|
| | t_{R} = 20 s | t_{R} = 13 s | | t_{R} = 13 s |
| | CO₂ plasma | CO₂ plasma | CO₂/O₂ Plasma | CO₂/O₂ Plasma |
| Moisture | 0.6 | 0.2 | 0.5 | 0.7 |
| (%) | | | | |

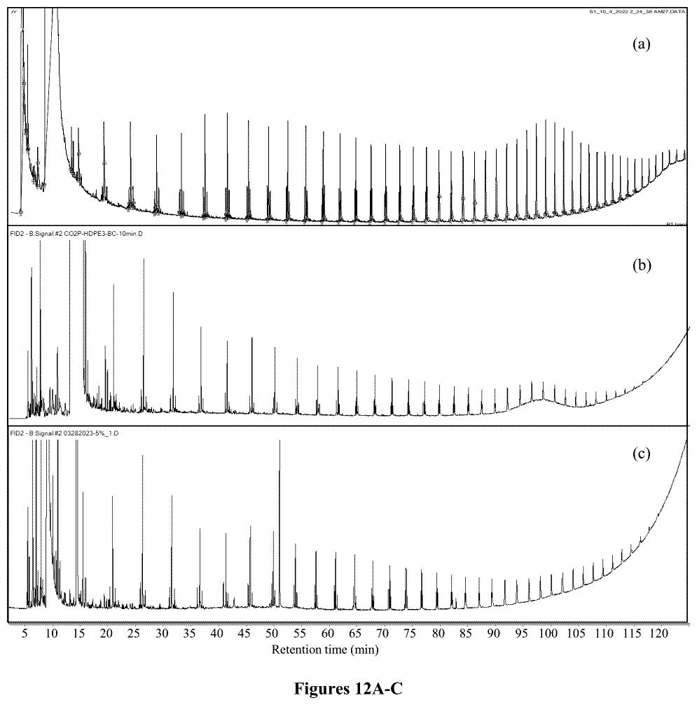

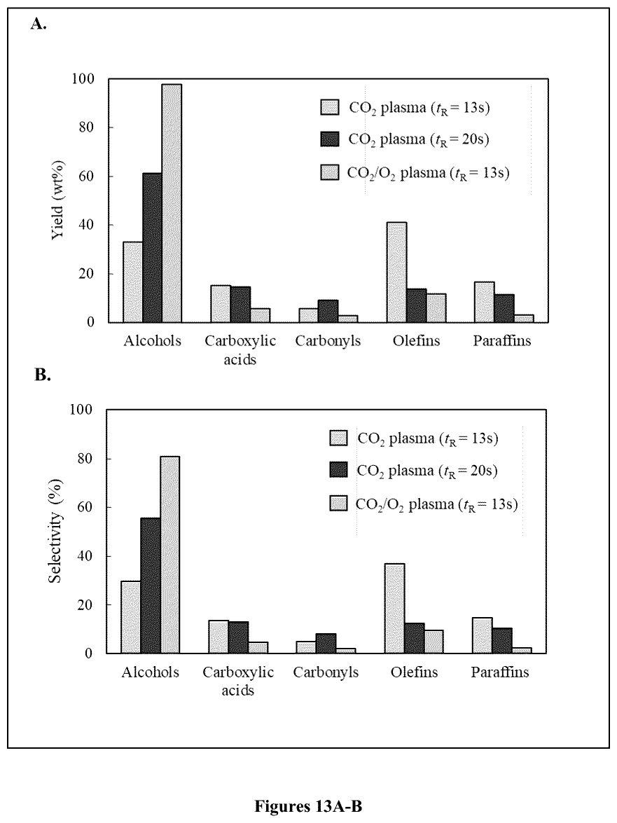

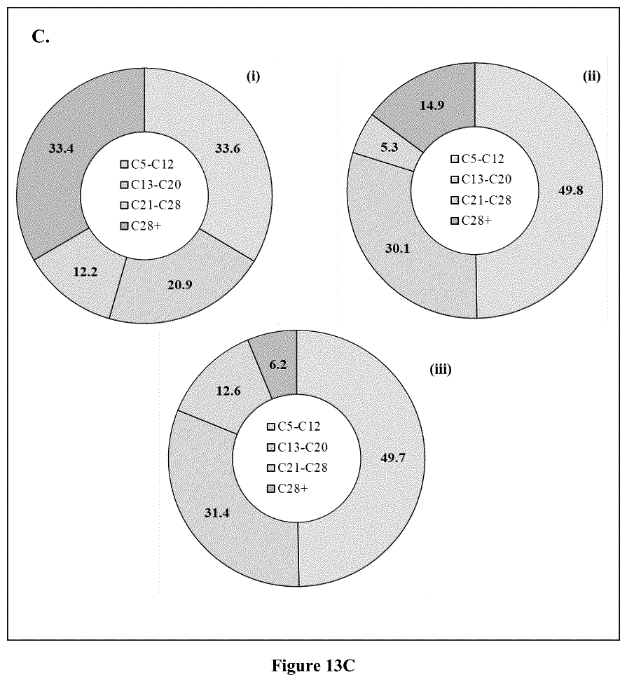

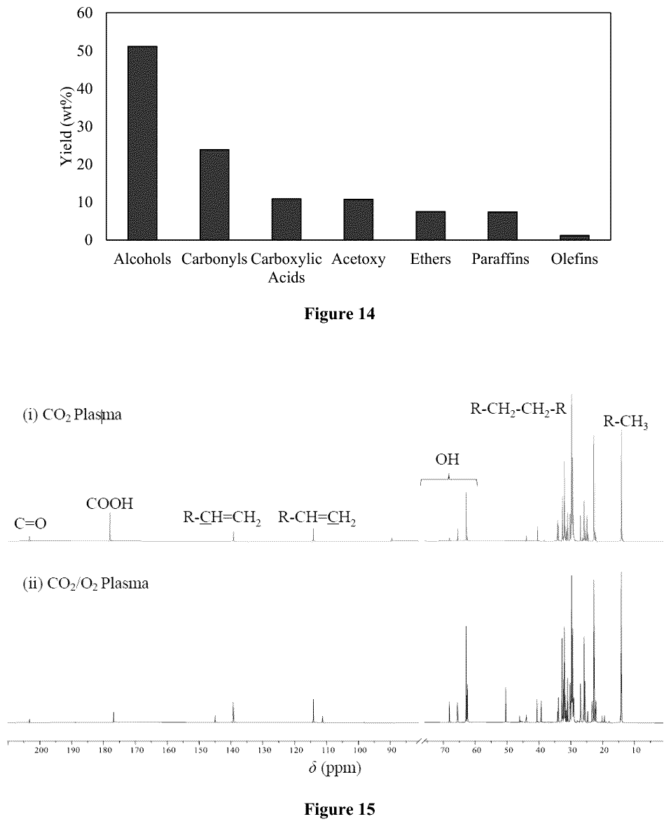

The chemical compositions of the liquids were analyzed using high-temperature gas chromatogram/mass spectrometry (HT-GC/MS). Overall, the liquids produced with a higher t_{R} or using CO₂/O₂ plasma instead of CO₂ plasma exhibited narrower molecular weight distributions of shorter-carbon chain-length compounds attributing to the higher degrees of bond cleavages in PE (the GC/MS chromatograms compared in FIG. 12, the product carbon number distribution included in Table 3). Liquids consisted of fatty alcohols, fatty acids, aliphatic carbonyls (ketones, aldehydes, and esters), paraffin, and olefins, whereas the functional group selectivity strongly depended on reaction conditions, especially the plasma gas composition. For the CO₂ plasma (t_{R}=20s) case, 61.1 wt % of fatty alcohols (or 55.6% per liquid), 14.5 wt % of fatty acids (or 13.2% per liquid), and 9.0 wt % of carbonyls (or 8.2% per liquid) produced, totaling 84.6 wt % of oxygenated liquids (or 77.0% per liquid) (FIGS. 13A-B). The rest of the liquids were olefins and paraffins. In comparison, supplementing CO₂ with O₂ as plasma gas not only increased the liquid yield and oxidation degree, as previously noted, but it also severely altered the product selectivity to increase fatty alcohols dramatically. With CO₂/O₂ plasma (t_{R}=13s), fatty alcohol yield accounted for 97.6 wt % (or 80.9% per liquid), consisting of selectivities of 49.7% of C₅-C₁₂ alcohols, 44.1% of C₁₃-C₂₈ alcohols and 6.2% C₂₈₊ alcohols (FIG. 13C). These include 12.7 wt % of di-alcohols, and the rest being mono-alcohols. While applying CO₂/O₂ plasma decreased the selectivity of hydrocarbons and other oxygenates significantly, the hydrocarbon compounds in the liquid were only C₇-C₁₀ paraffins and olefins. Noteworthy, such a selective production of fatty alcohols was not observed when PE was converted using air plasma. Although the degree of oxidation was higher by using air plasma than CO₂ plasma, the fatty alcohols only accounted for 51.1 wt % per PE (FIG. 14). With air plasma, a significant amount of carbonyl, acetoxy esters, and ether functional group compounds were also produced in addition to the fatty alcohols and acids.

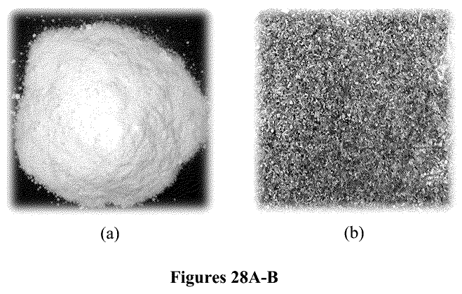

The selective production of fatty alcohols by CO₂/O₂ plasma was further confirmed by conducting ¹³C NMR analysis on the liquids (FIG. 15). For the liquid produced using CO₂ plasma (t_{R}=20s), the NMR spectrum exhibits the peaks of alcohols (OH, δ=60-95 ppm), carboxylic acids (COOH, δ=175-180 ppm), carbonyls (C═O, δ=180-210 ppm), R—CH═CH₂ bonds (δ=135-140 ppm), methyl (—CH₃, δ=10-20 ppm) and methylene (—CH₂, δ=110-15 ppm), representing the products with oxygenated functional groups or aliphatic hydrocarbons identified in the GC/MS analysis. In comparison, OH, methyl, and methylene are the dominant peaks for the liquid produced using CO₂/O₂ plasma (t_{R}=13 s), suggesting a prevalence of mono-alcohol structures. The peaks of other oxygen-containing functional groups are minor, indicating their low concentrations in the liquid. The ¹³C NMR results were used to calculate the functional group selectivity (Table 5) semi-quantitatively. Notably, the ¹³C NMR results agree with the GC/MS-based results above, confirming that fatty alcohols are selectively produced when CO₂/O₂ plasma is employed. In this work, in addition to gas composition and flow rate, the frequency and voltage of the plasma power source also affected PE and CO₂ conversion. The results of the parametric study and discussion are given in FIGS. 28-31 and the “Parametric Study on Plasma Conversion” section included later in this disclosure.

TABLE 5
¹³C NMR-based functional group selectivity of liquids
produced from PE using CO₂ and CO₂/O₂ plasma. Reaction
conditions: 15 kV, 8 kHz, 10 min. t_{R} is 20 s for CO₂ plasma,
and 13 s for CO₂/O₂ plasma.

Plasma type

| Functional Group | CO₂ | CO₂/O₂ |
|---|---|---|
| Alcohols | 54.3 | 74.9 |
| Carboxylic acids | 16.2 | 5.1 |
| Other oxygenated compounds | 3.3 | 1.6 |
| Hydrocarbons | 26.2 | 18.5 |

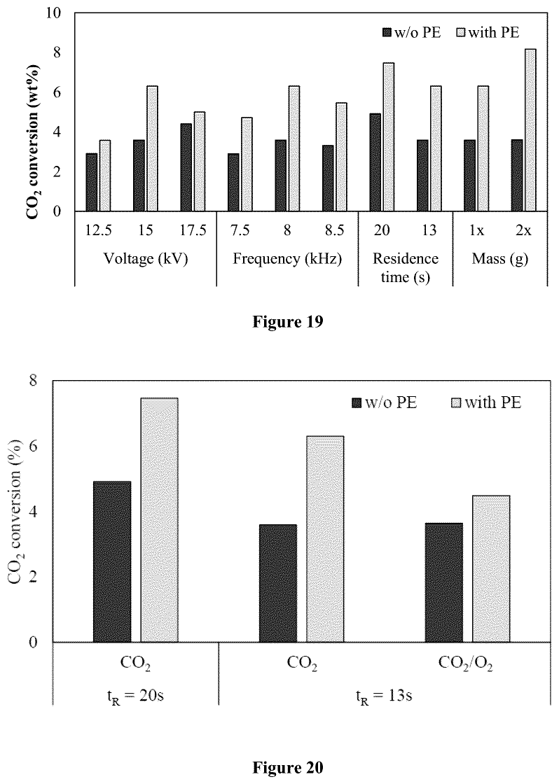

As shown above, CO₂ could initiate oxidative PE depolymerization, forming oxygenated chemicals and producing CO gas. On the other hand, the effect of PE on CO₂ conversion was evaluated by converting pure CO₂ or the CO₂/O₂ mixture gas in an empty plasma reactor to determine CO₂ conversion without PE. CO₂ conversions with PE co-present inside the reactor are higher than those without PE in all the tested cases (FIG. 20), indicating that the co-conversion approach also synergistically increases CO₂ conversion. The increased CO₂ conversion and the oxygen-functionalized products are due to strong interactions between PE and CO₂ under plasma discharge. Applying an electric field to CO₂ can introduce electron collision impact, forming radicals, ions, and other metastable particles of CO₂, CO, O, O₂, C, and many more (Aerts et al., “Carbon Dioxide Splitting in a Dielectric Barrier Discharge Plasma: A Combined Experimental and Computational Study,” ChemSusChem 8: 702-716 (2015), which is hereby incorporated by reference in its entirety). However, the CO₂-derived particles can also recombine, reducing the overall conversion of CO₂ (Zhang and Harvey, “CO₂ Decomposition to CO in the Presence of up to 50% O₂ Using a Non-thermal Plasma at Atmospheric Temperature and Pressure,” Chemical Engineering Journal 405: 126625 (2021); Fromentin et al., “Study of Vibrational Kinetics of CO₂ and CO in CO₂—O₂ Plasmas Under Non-equilibrium Conditions,” Plasma Sources Science and Technology 32: 024001 (2023); which are hereby incorporated by reference in their entirety). When PE is exposed to CO₂ plasma discharge, energetic electrons and reactive species of CO₂ plasma can attack the polymer by cleaving its C—C and C—H bonds (Diaz-Silvarrey et al., “Monomer Recovery Through Advanced Pyrolysis of Waste High Density Polyethylene (HDPE),” Green Chemistry 20: 1813-1823 (2018); Kang et al., “Feasibility Test of a Concurrent Process for CO₂ Reduction and Plastic Upcycling Based on CO₂ Plasma Jet,” Journal of CO₂ Utilization 52: 101701 (2021); which are hereby incorporated by reference in their entirety) and further reacting with the PE-derived fragments (Martini et al., “Oxidation of CH₄ by CO₂ in a Dielectric Barrier Discharge,” Chemical Physics Letters 593: 55-60 (2014), which is hereby incorporated by reference in its entirety). This way, CO₂ plasma can depolymerize PE, whereas PE acts as a scavenger to inhibit the recombination reactions among CO₂-derived species. The synergistic increase of CO₂ conversion was more noticeable with the longer t_{R} (the t_{R}=20s case compared to the t_{R}=13s case), confirming that the chemical quenching effect can be enhanced by increasing CO₂ and PE interactions under the plasma discharge. In this work, it was also found that doubling PE mass for the CO₂ plasma (t_{R}=13s) case increases CO₂ conversion from 6.3% to 8.1% (FIG. 19) despite the CO₂ flow rate at the reactor inlet remaining unchanged, likely attributed to the increased scavenger concentration due to the higher PE mass.

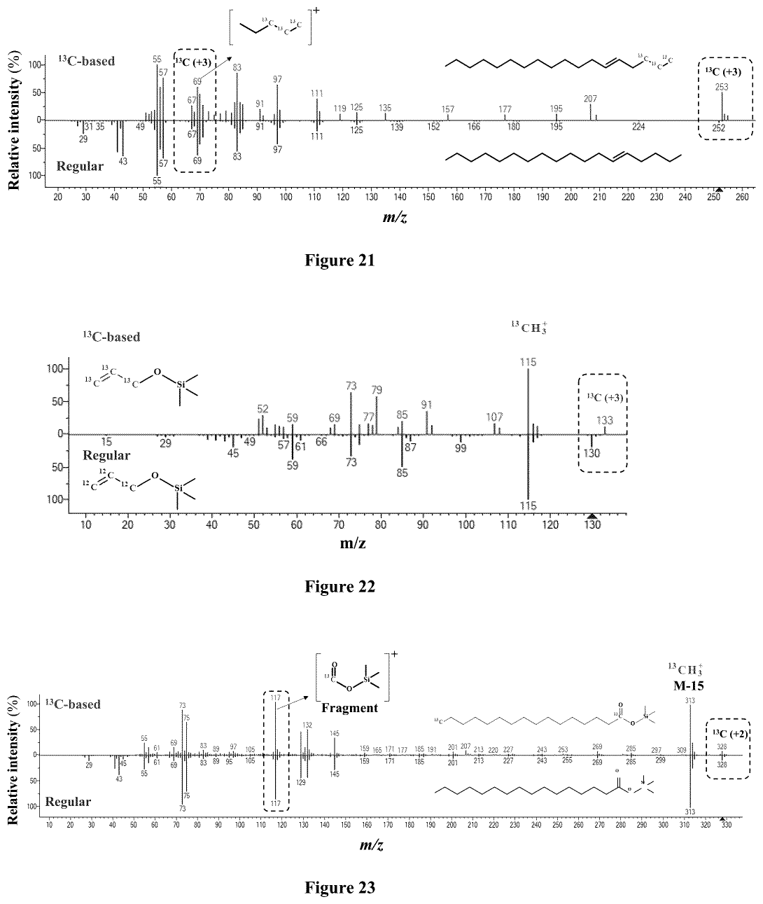

Plasma discharge causes CO₂ and O₂ (in the case of CO₂/O₂ plasms) to generate a series of carbon and oxygen-containing species. During the co-conversion, PE also produces hydrogen and hydrocarbon fragments if varying chain lengths. Although PE, CO₂, and O₂ can form a complex mixture of species inside the plasma reactor, the resultant products displayed a high selectivity towards specific functional groups. Therefore, multiple reactions involving different plasma species most likely funneled down to the same type of products. The interactions between CO₂ and PE were investigated in this work by converting isotopic ¹³CO₂ and eicosane (as a model compound of PE) by plasma. The CO₂-originated carbon atoms in the compounds were tracked by analyzing the liquid product using GC/MS and comparing the mass-to-charge ratios (m/z) of the compounds resulting from the isotopic test with that of the corresponding standard compounds. Despite ¹³CO₂ being more difficult to dissociate than regular CO₂ (Zeng et al., “Carbon Isotope Effects in the Artificial Photosynthesis Reactions Catalyzed by Nanostructured Co/CoO,” Chemical Physics Letters 754: 137731 (2020), which is hereby incorporated by reference in its entirety), ¹³C carbons were successfully identified in the conversion products (See FIGS. 21-25, Tables 6-7).

Isotopic Study for the Reaction Mechanism

CO₂-based plasma conversions of model compound (eicosane) were carried out using ¹³CO₂ to distinguish CO₂-originated carbon and plastic-originated carbon in the products. The model compound was also converted using regular ¹²CO₂ plasma to aid product identification in GC/MS. The number of CO₂-originated carbons and their possible positions in a molecule were determined by comparing the mass-to-charge ratio (m/z) of the ¹³CO₂ plasma-based molecule in its mass spectra (MS) and that of the corresponding regular molecule obtained using regular CO₂ plasma or NIST library database. When one ¹²C atom in a molecule having m/z=M is substituted by one ¹³C atom, it would cause an increase of the m/z value by one mass unit (m/z=M+1). In this work, ¹³C carbons were observed in product compounds with four different functional groups (e.g., hydrocarbon, alcohol, carboxylic acid, and carbonyl). The results are discussed below using representative compounds found in liquid product analysis.

Hydrocarbon

FIG. 21 shows the m/z distribution of 5-octadecene obtained with ¹³CO₂ plasma (upper) compared to the regular compound (lower). The molecular peak ion of regular 5-octadecene has an m/z value of 252, whereas the compound obtained with ¹³CO₂ plasma exhibited three m/z peaks at 253, 254, and 255. These results indicated that up to three carbons in the olefin were substituted by CO₂-originated carbons. The additional fragment peaks of alkyl ions at m/z 69 to 72 were also detected in the compound based on ¹³CO₂ plasma. These results can be used to locate the position of ¹³C atoms being replaced, where three ¹³C atoms are expected to be at the chain end of the molecule.

Alcohol

FIG. 22 shows mass spectra of allyl alcohol, trimethylsilyl (TMS) derivative compared between the ¹³CO₂ plasma case (upper) and regular ¹²CO₂ plasma case (lower). In this work, the compound was silylated by TMS to detect and increase the 10 GC signals of alcohol and carboxylic acid compounds. The H atom in both compounds is substituted by trimethylsilyl (—Si—(CH₃)₃). The regular allyl alcohol showed the m/z value at 130, whereas the m/z value of the ¹³CO₂ plasma-based compound appeared at 133. These results indicated that the alcohol could contain up to three CO₂-originated carbon atoms.

Carboxylic Acid

FIG. 23 shows the mass spectra of palmitic acid, TMS derivative compared between the ¹³CO₂ plasma-based compound (upper) and regular compound (lower). Both spectra showed m/z values at 328 (final mass ion), 329 (M+1), and 330 (M+2). The presence of ¹³C atoms in nature causes the extra MS peaks to appear in the regular compound. When the relative m/z peak intensity ratios at 329 to 328 and 330 to 328 are considered, both ratios for the ¹³CO₂ plasma-based compound (Entry 5-6, Table 6) are higher than those for the regular compound. These results implied that the compound contains up to two CO₂-originated carbon atoms.

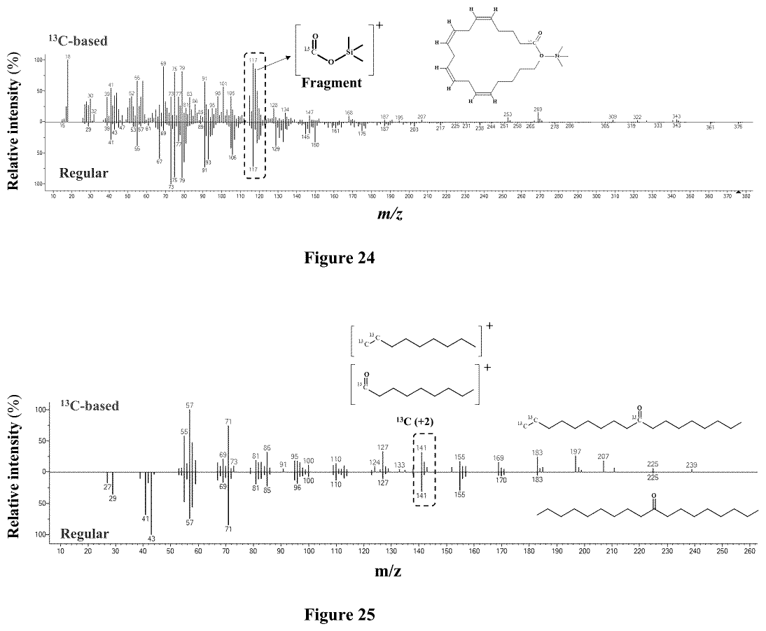

The fragment peaks were also considered to locate the position of the ¹³C atoms in the molecule. Both spectra (FIG. 23) exhibited strong peak signals at m/z 313 due to fragment cleavage of methyl groups (M−15). The relative m/z peak intensity ratios at 314 to 313 and 315 to 313 (Entry 3-4, Table 6) are the same for both spectra, indicating that one ¹³C atom is located at the chain end of the molecular structure. Another ¹³C atom is possibly located at the carboxylic functional groups, according to the fragment of the silylated carboxylic groups (—C═O—O—Si—(CH₃)₃) at m/z 117. Both m/z intensity ratios of 118 to 117 and 119 to 117 (Entry 1-2, Table 6) for the ¹³CO₂-based compound are higher than those for the regular compound. We also evaluated an additional carboxylic compound (arachidonic acid) to confirm these results, as shown in FIG. 24. It was found that both ratios for the ¹³CO₂-based compound (Entry 7-8, Table 6) are also higher than those of the corresponding regular compound.

Carbonyl

FIG. 25 shows the mass spectra of 9-octadecanone compared between the ¹³CO₂ plasma-based case (upper) and regular case (lower). Since the final m/z of 268 was not shown in both spectra, the fragments of 9-octadecanone were evaluated. Both spectra (FIG. 25) exhibited strong peak signals at m/z 141 due to fragments of alkyl ion (C₁₀H₂₁)⁺ and acyl ion (C₉H₁₇O)⁺. While the regular compound showed one extra m/z peak at 142, the ¹³CO₂ plasma-based compound showed two extra m/z peaks at 142 and 143. In addition, the relative m/z peak intensity ratios of ¹³CO₂ plasma-based compound spectra at 142/141 and 143/141 (Table 7) are higher than those of the regular compound. These results implied that the molecule could contain up to two CO₂-originated carbon atoms.

TABLE 6
m/z peak intensity ratios of palmitic acid, TMS derivative,
and arachidonic acid, TMS derivative for their regular molecules and
¹³CO₂ plasma-based molecules.

| | | | |
|---|---|---|---|
| Entry | m/z | Regular | ¹³CO₂ plasma-based |

Palmitic acid, TMS derivative

| | | | |
|---|---|---|---|
| 1 | 118/117 | 9.8% | 10.3% |
| 2 | 119/117 | 4.0% | 5.5% |
| 3 | 314/313 | 24.1% | 24.2% |
| 4 | 315/313 | 6.4% | 6.1% |
| 5 | 329/328 | 27.3% | 29.1% |
| 6 | 330/328 | 7.9% | 13.4% |

Arachidonic acid, TMS derivative

| | | | |
|---|---|---|---|
| 7 | 118/117 | 14.7% | 91.1% |
| 8 | 119/117 | 43.0% | 53.2% |

TABLE 7
m/z peak intensity ratios of 9-octadecanone for the
regular molecule and ¹³CO₂ plasma-based molecule.

| Entry | m/z | Regular | ¹³CO₂ plasma |
|---|---|---|---|
| 1 | 142/141 | 13% | 50.9% |
| 2 | 143/141 | 0% | 24.5% |

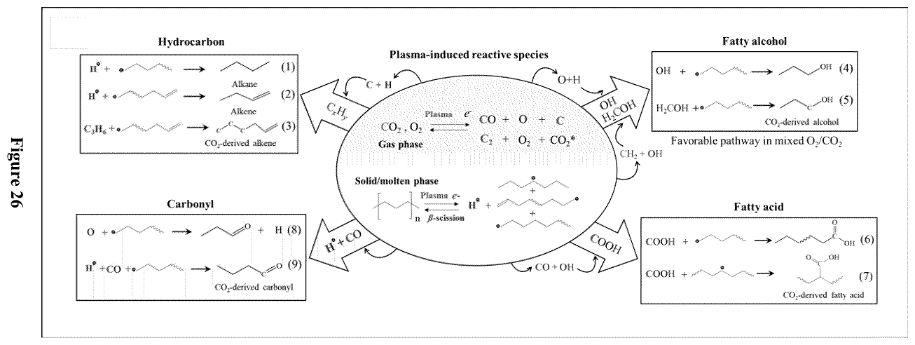

Based on the isotopic test results, the possible reaction mechanisms of PE and CO₂ co-conversion are proposed in FIG. 26. Under plasma discharge, the electrons and metastable CO₂-derived plasma species (e.g., CO₂, CO, O, C, C₂ and more) in the gas phase could attract molten PE to cleave its C—H and C—C bonds, forming the radicals of hydrogen and hydrocarbons with reduced chain lengths. The subsequent β-scission of the hydrocarbon radicals leads to alkenes and hydrogen radicals (H^{·}). Alternatively, the hydrocarbon radicals could also become saturated to form alkanes and alkenes by eqs. (1) and (2), respectively. From the isotope results, CO₂-derived C atoms (up to 3 atoms) presented themselves in alkene products at their chain ends (FIG. 21). Accordingly, the possible reaction pathway for CO₂-originated carbons to enter the alkene products can be a two-step process: (i) formation of CₓH_{y} radicals from CO₂-originated C and PE-derived H and (ii) further coupling reaction with hydrocarbon radicals (eq. (3)).

PE-derived H and CO₂-derived O could form OH, which can further combine hydrocarbon radicals to produce fatty alcohols (eq. (4)). The CO₂-originated C atom linked to the OH in alcohols was also detected in the isotope results (FIG. 22), suggesting the alcohol products can also form via H₂COH intermediates containing CO₂-originated carbon ((Martini et al., “Oxidation of CH₄ by CO₂ in a Dielectric Barrier Discharge,” Chemical Physics Letters 593: 55-60 (2014); Graciani et al., “Highly Active Copper-ceria and Copper-ceria-titania Catalysts for Ethanol Synthesis From CO₂,” Science 345: 546-550 (2014); Wang et al., “Atmospheric Pressure and Room Temperature Synthesis of Methanol through Plasma-Catalytic Hydrogenation of CO₂,” ACS Catalysis 8: 90-100 (2018); which are hereby incorporated by reference in their entirety), eq. (5)). Although OH can also combine with H to form water, this undesired reaction was not significant because the water content in the liquid products was negligible.

CO and OH can react with hydrocarbon radicals to form fatty acids (eqs. (6)-(7)) (Martini et al., “Oxidation of CH₄ by CO₂ in a Dielectric Barrier Discharge,” Chemical Physics Letters 593: 55-60 (2014); Yu et al., “A Theoretical Study of the Potential Energy Surface for the Reaction OH+CO→H+CO₂,” Chemical Physics Letters 349: 547-554 (2001); which are hereby incorporated by reference in their entirety). The metastable CO₂ and H could directly react with the hydrocarbon radicals to form the acids. However, this route has a much higher energy barrier than the previous route (Yu et al., “A Theoretical Study of the Potential Energy Surface for the Reaction OH+CO→H+CO₂,” Chemical Physics Letters 349: 547-554 (2001); Wang et al., “A DFT Study of Synthesis of Acetic Acid From Methane and Carbon Dioxide,” Chemical Physics Letters 368: 313-318 (2003); which are hereby incorporated by reference in their entirety). Carbonyl products are generated from O bonding with the hydrogen-abstracted hydrocarbon radicals (eq. (8)) or carbonylation reactions of CO with hydrocarbon radicals (eq. (9)). The isotope results confirmed the CO₂-originated C atoms in carboxylic (COOH) (FIGS. 23 and 24, Table 6) and carbonyl (C═O) groups (FIG. 25, Table 7), which were in accordance with the reaction pathways shown in eqs. (6) and (9), respectively. As described above, fatty alcohols were strongly promoted when a small amount of O₂ was introduced to CO₂ at the reactor inlet. Oxygen plasma produces active oxygen species (e.g., O, O₂, O₃) in addition to electrons (Zhang and Harvey, “CO₂ decomposition to CO in the Presence of up to 50% O₂ Using a Non-thermal Plasma at Atmospheric Temperature and Pressure,” Chemical Engineering Journal 405: 126625 (2021); Fromentin et al., “Study of Vibrational Kinetics of CO₂ and CO in CO₂—O₂ Plasmas Under Non-equilibrium Conditions,” Plasma Sources Science and Technology 32: 024001 (2023); which are hereby incorporated by reference in their entirety). Thus, CO₂/O₂ plasma discharge is expected to have a higher oxygen radical concentration than CO₂ plasma discharge. As described in Table 3, the liquid produced using CO₂/O₂ plasma had an overall lower carbon number distribution in their products than the liquid produced using CO₂ plasma. This result suggests that C—C and C—H bond scissions in PE polymer are more extensive with CO₂/O₂ plasma, could produce shorter chain hydrocarbon radicals and release more hydrogen radicals. Accordingly, the higher O and H concentrations in CO₂/O₂ plasma discharge will increase OH formation, promoting the alcohol-forming reactions and reducing hydrocarbon products. Fatty acids were reduced significantly, possibly due to the reduced availability of the reactive CO intermediate species. Notably, CO₂ conversion was lower under CO₂/O₂ plasma than under CO₂ plasma under the same reaction conditions, suggesting the increased O in the system consumes some CO₂-derived CO species to form CO₂. This increased combination reaction due to the supplemented O₂ will reduce the PE-induced chemical quenching effect of CO₂ compared to pure CO₂ plasma (confirmed in FIG. 20, the extent of synergistic increase in CO₂ conversion was lower for CO₂/O₂ plasma). However, fewer CO species and higher OH concentration paired with the scarcity of unbonded O species, combined with higher reactivity of OH-derived species (Wang et al., “Modeling Plasma-based CO₂ and CH₄ Conversion in Mixtures with N₂, O₂, and H₂O: The Bigger Plasma Chemistry Picture,” The Journal of Physical Chemistry C 122: 8704-8723 (2018); Slaets et al., “CO₂ and CH₄ Conversion in “Real” Gas Mixtures in a Gliding Arc Plasmatron: How Do N₂ and O₂ Affect the Performance?,” Green Chemistry 22: 1366-1377 (2020); which are hereby incorporated by reference in their entirety), likely resulted in the selective production of fatty alcohols under CO₂/O₂ plasma. If excess oxygen is supplied, the overwhelming presence of O species could introduce many additional oxidative reactions, as found with air plasma. It is worth noting that the reaction system involving the solid and gas phase feedstocks undergoing multi-phase processes for physical changes and chemical reactions, along with the inherent complexity of the plasma discharge, is expected to include many additional intermediates and reactions not listed here. In future work, the in-situ measurements of reaction intermediates assisted by the computational study are needed to gain better insights into the plasma-based co-conversion of plastics and CO₂. Nevertheless, these results show the possibility of controlling the product selectivity of plasma reactions using a surprisingly straightforward and feasible approach.

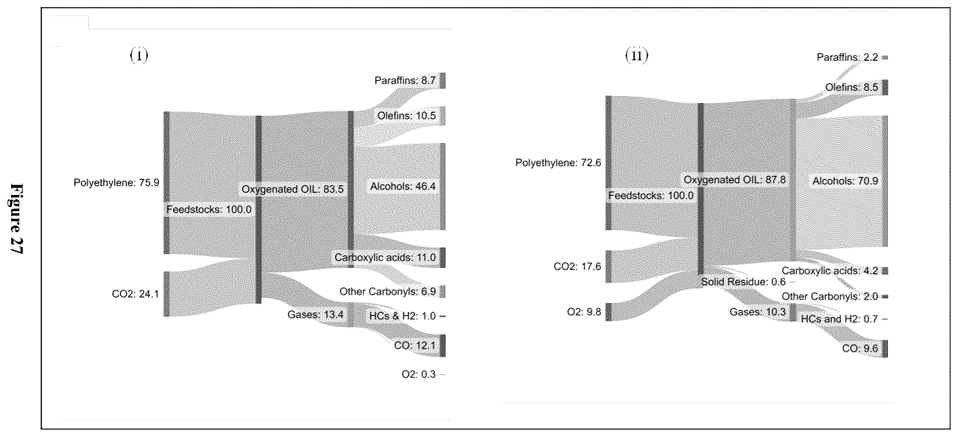

The above work shows that the co-conversion of CO₂ and PE by plasma was highly effective in synergistically promoting the conversion of both CO₂ and PE while chemically storing CO₂ into valuable platform chemicals using PE is a carbon sink. FIG. 27 shows the mass balances of CO₂ plasma or CO₂/O₂ plasma-based co-conversion systems for all reactants and measured products (mass closures of 96.9% and 98.6%, Table 8). If the reactant mass is 100 g, 75.9g of PE and 24.1 g of CO₂ are converted in the CO₂ plasma (t_{R}=20s) case to produce 46.4 g of fatty alcohols, 11 g of fatty acids, 10.5 g of olefins and 8.7 g of paraffin. Additionally, 12.1 g of CO gas is also produced (other minor product masses in FIG. 27). For the CO₂/O₂ plasma (t_{R}=13s) case, 72.6 g of PE, 17.6 g of CO₂, and 9.8 g of O₂ are converted to produce 70.9 g of fatty alcohols, 4.2 g of fatty acids, 8.5 g of olefins, 2.2 g of paraffins, and 9.6 g of CO gas.

TABLE 8
Mass closures of plasma-based co-conversion of plastics and CO₂
including all reactants and measured products. The gas, liquid and
solid residue yields are calculated based on the total reactant masses,
which are converted PE and CO₂ for the CO₂ plasma case, and
converted PE, CO₂ and O₂ for the CO₂/O₂ plasma cases.

| | | | | | Solid | |
|---|---|---|---|---|---|---|
| | | | Gas | Liquid | Residue | Total |
| Plastic | t_{R} | Plasma | (%) | (%) | (%) | (%) |
| PE | 20 s | CO₂ | 13.4 | 83.5 | 0.0 | 96.9 |
| PE | 13 s | CO₂/O₂ | 10.3 | 87.7 | 0.6 | 98.6 |
| PC-PE | 13 s | CO₂/O₂ | 9.8 | 82.1 | 1.8 | 93.7 |

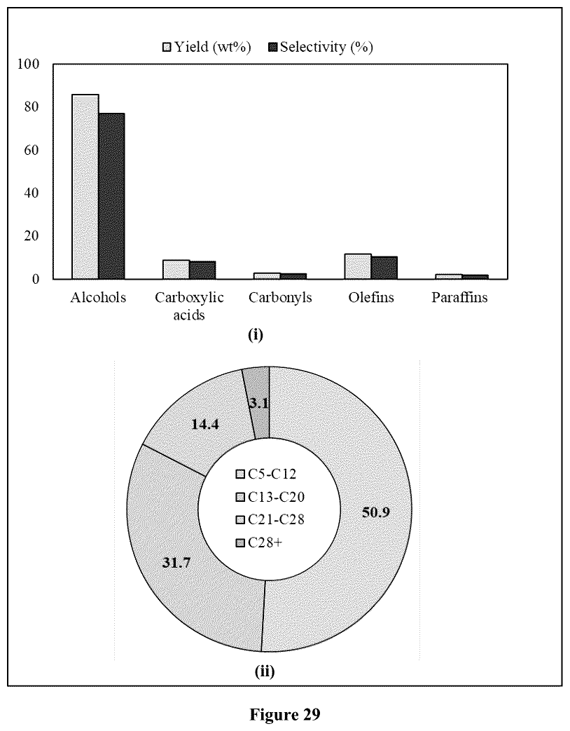

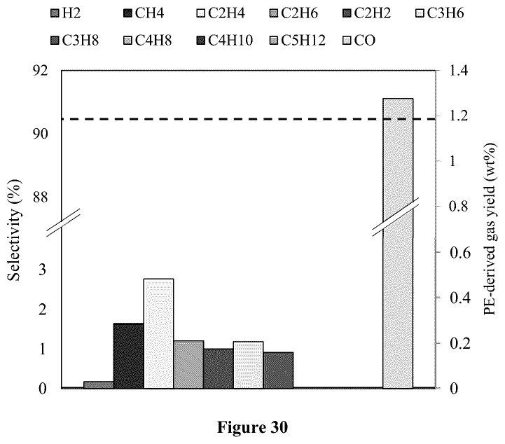

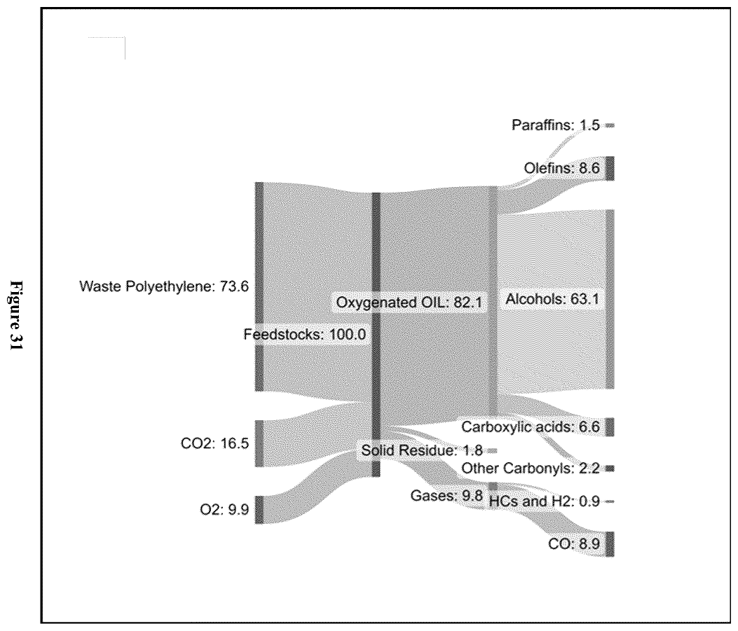

The applicability of the plasma-based co-conversion was evaluated using waste plastics as the feedstock. Mix-colored post-consumer PE (PC-PE) collected from a material recovery facility was washed and sized before conversion (FIG. 28). With PC-PE, the liquid yield of 111.5 wt % was achieved using CO₂/O₂ plasma (t_{R}=13s) after 10 min with a lower initial reactor temperature of 325° C. There was also 2.9 wt % of solid remaining in the reactor, mostly from the impurities in the plastic feedstock. CO₂ conversion with PC-PE was 4.1%, again higher than 3.6% for converting CO₂ and O₂ mixture gas without plastics. The characterization of the liquid product (Tables 3, 4) revealed that the liquid derived from PC-PE had a slightly narrower molecular weight distribution, comparable oxygen content (10.9%), and negligible water content compared to the virgin PE-derived liquid. Notably, the functional group selectivity in the liquid was comparable for PC-PE or PE as the feedstock (FIG. 29). Fatty alcohols were the dominant liquid product, whose yield was 85.8 wt % per PC-PE feedstock mass, accounting for 76.9% of liquid. The fatty alcohols were mostly <C₂₈ compounds (FIG. 29-ii), which was also similar to the PE-derived liquid. For the gas products, CO selectivity was 91.1%, and the plastic-derivable gas yield was only 1.2% (FIG. 30). The mass balance of the co-conversion system for PC-PE conversion by CO₂/O₂ plasma is shown in FIG. 31 (93.7% of mass closure, given in Table 8). Starting with 100 g of feedstock, 73.6 g of PC-PE, 16.5 g of CO₂, and 9.9 g of O₂ are converted to produce 63.1 g of fatty alcohols, 6.6 g of fatty acids, 8.6 g of olefins, and 8.9 g of CO gas. These results show promise for applying the current approach to waste plastics.

The potential for broader adaptation and applicability of the co-conversion concept was further evaluated by measuring external energy consumption for CO₂/O₂ plasma-based conversion using two different feedstock loadings and reactor sizes. A 107.8 wt % of liquid was obtained by converting 1 g of PE for 7.5 min in a larger reactor, compared to 120.7 wt % liquid produced after 10 min with 0.15 g PE in the original reactor. Meanwhile, external energy consumption dropped drastically in the reactor with higher PE and gas flow rate, from 237.2 MJ/kg with 0.15 g PE to 44 MJ/kg with 1 g PE, partially attributed to more effective utilization of plasma discharge zone for converting larger feedstock masses in the larger reactor (Table 9). It is common knowledge that process energy strongly depends on the conversion scale and decreases as it increases. Literature reported the external energy consumed for pyrolyzing plastics at a bench scale reactor to be 118 MJ/kg for PP at 1.007 kg/h plastic feed rate, 77.6 MJ/kg at 1.496 kg/h, and 35.2 MJ/kg at 3.088 kg/h for polypropylene-polyethylene terephthalate (PP-PET) films (Kodera et al., “Energy- and Economic-Balance Estimation of Pyrolysis Plant for Fuel-Gas Production from Plastic Waste Based on Bench-Scale Plant Operations,” Fuel Communications, 7: 100016 (2021), which is hereby incorporated by reference in its entirety). The same literature reported that the energy consumption of plastic pyrolysis decreases substantially in a commercial plant operation, estimating 9.9 MJ/kg for PP-PET films at a plastic feed of 200 kg/h. Another literature reported the energy demand for three Japanese thermal liquefaction plants converting waste plastics (see Section E of the Supplementary text for additional information) to be 21.1, 22.8, and 20.1 MJ/kg, respectively, for a feedstock capacity of 6000 tons/yr (or ˜$2300 kg/h, when 320 days/year and 8 h/day reactor operation is assumed (J. Scheirs and W. Kaminsky, Feedstock Recycling and Pyrolysis of Waste Plastics, J. Wiley & Sons (2006), which is hereby incorporated by reference in its entirety). The energy consumption rate in this work for converting much smaller feed mass was already comparable to other conventional conversion technologies for waste plastics and also the energy consumption showed a decrease as the feed mass increased, suggesting potentially higher energy efficiencies for plasma-based co-conversion if scaled up. Future studies will focus on innovative reactor designs and efficient feedstock feeding mechanisms to increase throughput while ensuring effective interactions among feedstocks under plasma discharge, which are essential in scaling the technology.

TABLE 9
Energy consumption of PE conversion by CO₂/O₂ plasma in
two different reactors. Reaction conditions: Run A - 50 mL/min
CO₂ with 8% v/v O₂, 15 kV, 8 kHz, 10 min; Run B - 100 mL/min
CO₂ with 12% v/v O₂, 15 kV, 7 kHz, 7.5 min; time required to
preheat to 350° C. is 4 min for Run A and 7 min for Run B.

| | Run A | Run B |
|---|---|---|
| PE (kg) | 1.55 × 10⁻⁴ | 1.015 × 10⁻³ |
| Converted CO₂ (kg) | 3.8 × 10⁻⁵ | 1.08 × 10⁻⁴ |
| Converted O₂ (kg) | 2.1 × 10⁻⁵ | 3.0 × 10⁻⁵ |
| Thermal energy (for pre-plasma | 3.02 × 10⁻⁴ | 1.479 × 10⁻³ |
| heating) (MJ) | | |
| CO₂: sensible heating* | 1.57 × 10⁻⁴ | 5.24 × 10⁻⁴ |
| O₂: sensile heating* | 8 × 10⁻⁶ | 4.3 × 10⁻⁵ |
| PE: sensile heating | 1.1 × 10⁻⁴ | 7.31 × 10⁻⁴ |
| PE: latent heating for melting | 2.7 × 10⁻⁵ | 1.82 × 10⁻⁴ |
| Plasma energy (MJ) | 5.0303 × 10⁻² | 4.9234 × 10⁻² |
| Total energy consumption (MJ) | 5.0604 × 10⁻² | 5.0713 × 10⁻² |
| Energy consumption per feeds | 237.23 | 43.97 |
| (MJ/kg) | | |

*Calculated for the total flow-in CO₂ or O₂ gas mass at the inlet during the pre-plasma heating stage

The state-of-the-art technologies for chemically upcycling polyolefins to platform chemicals usually require harsh reaction conditions, costly reactants, catalysts, toxic chemicals, or multi-step processes. In this context, the presented non-catalytic low-temperature plasma approach can selectively convert waste plastics into valuable chemicals in a single step using waste CO₂ as the co-reactant. Based on this approach, while the oleochemicals and aliphatic hydrocarbon products can be used as platform chemicals for various applications, the CO in the gas stream can be used for chemical synthesis, or as an energy source. When the gas product is used for energy, CO₂ produced after the gas combustion can be recycled in the plasma reactor. Moreover, CO₂/O₂ mixture gases could achieve higher product selectivity in this work, suggesting pure CO₂ gas is not required for this closed-loop conversion. Another compelling aspect of this approach is that the co-conversion process relies only on electricity to generate plasma, offering an opportunity to leverage increasingly abundant, low-cost renewable electricity generated from winds or solar to reduce carbon emissions and achieve a truly green upcycling of plastics and greenhouse gas sequestration. In future work, techno-economic analysis and life cycle assessment of the co-conversion approach for various final product compositions will be studied based on different electricity source scenarios (renewable vs. fossil-based). Overall, this study provides a promising solution to mitigate two major environmental problems by utilizing waste plastics and CO₂ in a circular carbon approach.

Thermal Effect on Plastic Conversion

Before plasma actuation started, the reactor was externally heated to 350° C. to melt plastic powders. The molten plastic mass right before applying plasma was the same as the initial PE mass, confirming no plastic decomposed during the preheating process. Although external heating was removed after the plasma actuation, the gas temperature inside the insulated reactor was higher than room temperature (Table 1) due to the mild joule heating during the plasma discharge. This thermal effect during the plasma-based conversion was evaluated by using a heater to maintain the reactor temperature at 350° C. or 400° C. without applying plasma. With a CO₂ flow of 50 mL/min (or t_{R}=13s) and a 20 min thermal heating without plasma, 95 or 88 wt % of PE remained unconverted. These results align with previous knowledge that the thermal decomposition of polyolefins requires much higher temperatures (Aboulkas et al., “Thermal Degradation Behaviors of Polyethylene and Polypropylene. Part I: Pyrolysis Kinetics and Mechanisms,” Energy Conversion and Management 51: 1363-1369 (2010), which is hereby incorporated by reference in its entirety). Since the measured reactor gas temperature during the plasma-based conversion was between 300 and 400° C. for most cases, this thermal heating-based test result suggests that the joule heating alone had a negligible effect on PE conversion. However, the gas temperature inside the plasma reactor can indirectly affect plastics and CO₂ conversion by influencing the intensity of plasma discharge. Stronger plasma discharge can be obtained with the same voltage and frequency conditions when the gas temperature is higher.

Parametric Study on Plastic Conversion

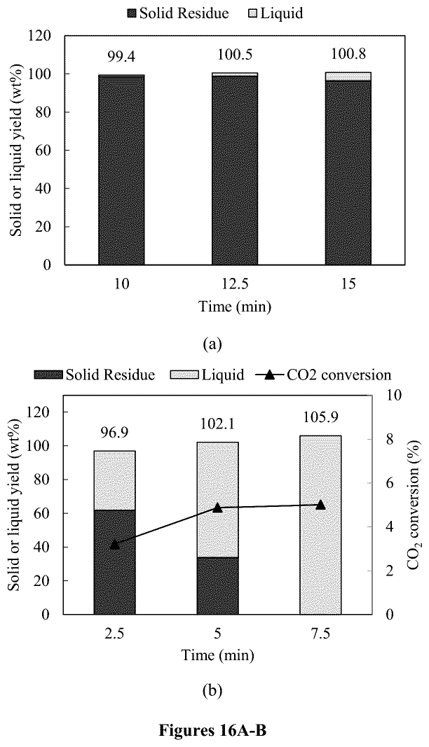

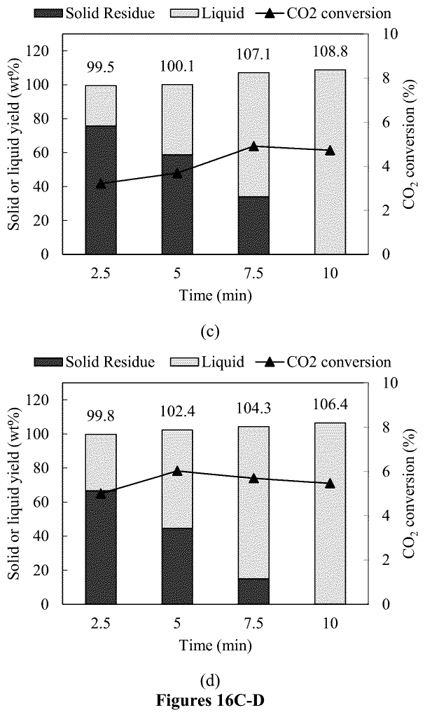

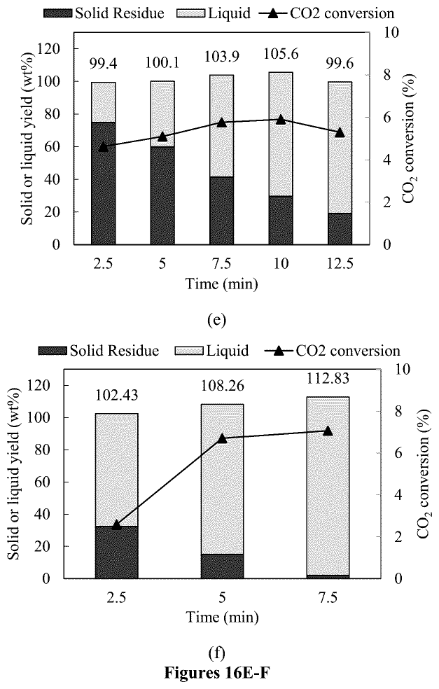

The effect of experimental conditions on plasma-based conversion is discussed in this section for CO₂ plasma. FIGS. 16-18 show time-dependent product yields, liquid selectivity of different functional group compounds, gas product selectivity, and CO₂ conversion for five different plasma conditions.

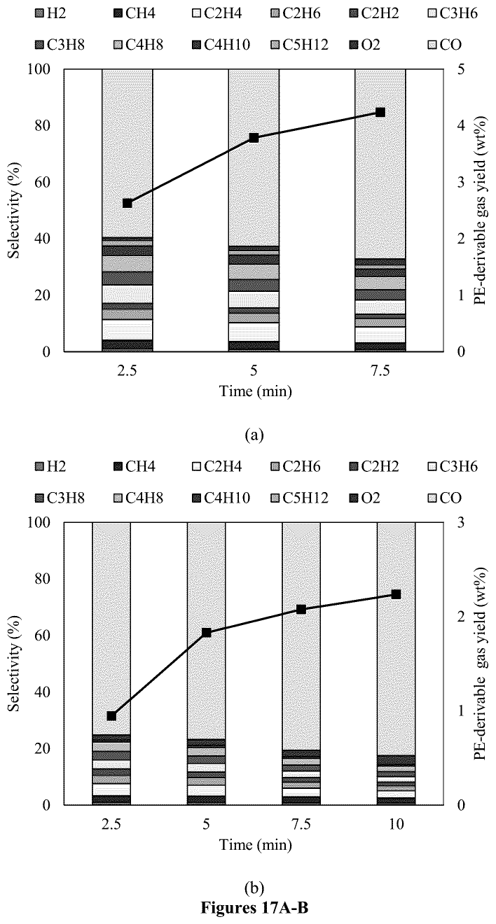

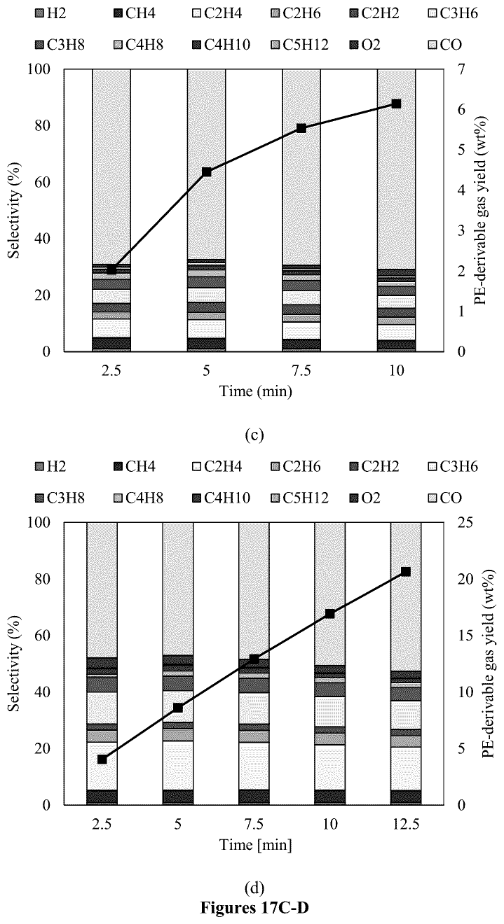

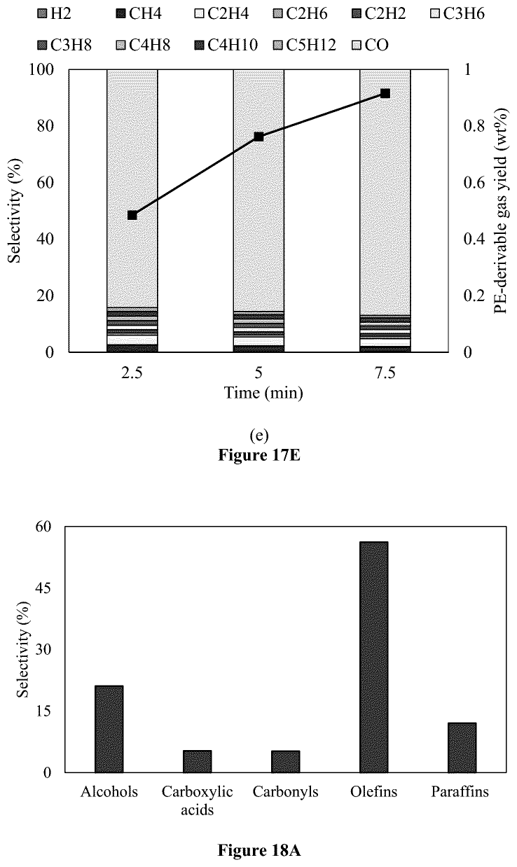

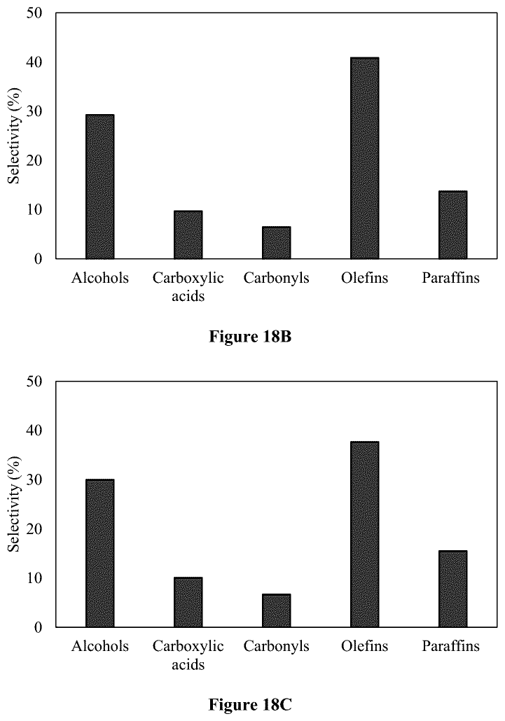

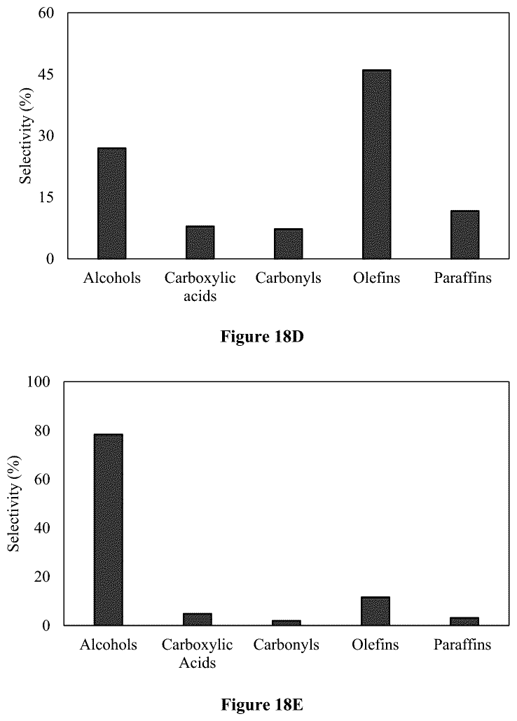

The effect of voltage during PE conversion by CO₂ plasma was studied using three voltages (12.5 kV 15 kV, and 17.5 kV) at a constant gas flow rate of 50 mL/min (t_{R}=13s) and frequency of 8 kHz. The reactor gas temperature was lowest (Table 1) and PE conversion was minimal with the 12.5 kV case (FIG. 16A). This voltage was near the threshold voltage for initiating plasma discharge and thus the low plasma intensity with this voltage caused slow PE conversion. Increasing the voltage from 15 kV to 17.5 kV caused an increase in reactor gas temperature during the plasma-based conversion (Table 1). The conversion rate also increased, completing PE conversion within 7.5 min (FIG. 16B) compared to within 10 min for the 15 kV case (FIG. 10A-i). However, the maximum liquid yield and the CO₂ conversions at the completion of PE conversion were lower for the 17.5 kV case than for the 15 kV case (105.9 wt % vs. 111.4 wt %, and 5% vs. 6.3%). The higher voltage also produced gas products with higher yield of PE-derived hydrocarbons and hydrogen. The CO selectivity in the gas products was 67.2% for the 17.5 kV case (FIG. 17A), lower than 84.9% for the 15 kV case (FIG. 10B-i). On the other hand, the product carbon number distribution shows the higher voltage results in the liquid with overall narrower molecular weight distribution with products of shorter carbon chain lengths. For example, a C₅-C₁₂ range product yield of 39.6 wt % was achieved at the 17.5 kV case, exceeding 28.2 wt % yield observed at the 15 kV case (Table 3). The liquid produced at the higher voltage was also less oxidized. The alcohols, carboxylic acid and other carbonyl selectivity at the 17.5 kV case (FIG. 18A) were 21.1, 5.3 and 5.3%, with a total oxygenated product selectivity of 31.7%. In comparison, the total oxygenated liquid product selectivity was 48.4% for the 15 kV case, which included 29.7% of alcohols, 13.6% of carboxylic acid, and 5.1% of other carbonyl compounds (FIG. 13B). Although the voltage had to be sufficient to convert PE and CO₂, the excessively high voltage resulted in less oxidized products from PE. Although the higher voltage increases plasma intensity to promote cleavages of the PE polymer chain, the increased joule heating effect also raised the reactor gas temperature. Due to their smaller molecular sizes and increased volatility at higher temperatures, the PE-derived hydrocarbons might have exited the reactor without sufficiently interacting with CO₂-derived species to form oxygenated chemicals. Therefore, 15 kV was determined to be the optimal voltage.

The frequency effect was studied by carrying out PE conversion using CO₂ plasma with three different frequencies (7.5 kHz, 8 kHz, and 8.5 kHz) at a constant gas flow rate of 50 mL/min (t_{R}=13s) and 15 kV. The frequency effect was similar to the voltage effect described above; an increase in frequency caused increases in the reactor gas temperature (Table 1) and PE conversion rate (FIG. 16C, FIG. 10A-i, and FIG. 16D). However, increasing the frequency from 8 kHz to 8.5 kHz could not further increase the liquid yield above 111.4% and CO₂ conversion above 6.3%, both obtained with the 8 kHz case. Among the gas products, the CO gas selectivity was 82.5% for the 7.5 kHz and 71% for the 8.5 kHz case (FIG. 17B and FIG. 17C), both lower than 84.9% for the 8 kHz case (FIG. 10B-i). The PE-derived hydrocarbon gas selectivity increased in the two former cases. Similar to what was observed with the voltage effect, increasing frequency also resulted in narrower carbon distributions and lighter compounds in the liquid product. For example, C₅-C₁₂ range product yield for the 8.5 kHz case was 39.2 wt %, compared to 22.4 wt % and 28.2 wt % for 7.5 and 8 kHz cases, respectively (Table 3). The selectivity of oxygenated compounds in the liquid product also decreased for the highest frequency of 8.5 kHz. The total selectivity of oxygenated products was 46.8%, including 30% of alcohols, 10.1% of carboxylic acids, and 6.7% of other carbonyls (FIG. 18C). Based on the results, the frequency of 8 kHz and voltage of 15 kV are determined to be the optimal condition for CO₂ plasma to produce high selectivity of oxygenated products and liquid yield.

The effect of gas residence time (t_{R}) was studied using the gas flow rates of 32.5, 50, and 65 mL/min using a fixed voltage (15 kV) and frequency (8 kHz), which correspond to t_{R}=20s, 13s and 10s, respectively. Compared to the two cases with higher t_{R}, the reactor gas temperature and PE conversion rate were both lower for the t_{R}=10s case (Table 1 and FIG. 16E). The liquid yield with 10s of t_{R} was only 80.6% after 12.5 min, and 19.1 wt % PE remained unconverted. Using this lowest t_{R} also caused decreased CO₂ conversion (5.3% at 12.5 min) (from FIG. 16E) and lower CO selectivity in the gas products (52.7% from FIG. 17D) due to the increased hydrocarbon selectivity. The low t_{R} also led to the liquid product with a higher molecular weight and lower degree of oxidation. For example, the C₅-C₁₂ compound yield in the liquid product collected after 12.5 min was 15.6 wt % (Table 3). The selectivity of the oxygenated compounds was 42.3%, consisting of 27% alcohols, 7.9% carboxylic acids, and 7.3% of other carbonyl products, respectively (FIG. 18D). In comparison, PE conversion rate, liquid yield, CO₂ conversion, CO gas selectivity, light compound yield, and the oxygenated compound selectivity were all higher for the t_{R}=13s and 20s cases (FIG. 10, FIG. 13A, FIG. 13B, and Table 3), although the liquid yield was slightly higher for the t_{R}=13s case than the t_{R}=20s case. These results show that allowing CO₂ and PE to sufficiently interact under the plasma zone is necessary to enhance the PE conversion rate and increase CO₂ conversion, producing oxygenated liquids with narrower molecular weight distribution and shorter carbon chain lengths.

For the CO₂/O₂ plasma case, the gas flow rates of 32.5 mL/min (t_{R}=20s) and 50 mL/min (t_{R}=13s) were studied under the optimized plasma discharge conditions of 8 kHz and 15 kV. PE devolatilization was completed within 7.5 min for the t_{R}=20s case (FIG. 16F), faster than it was observed with the t_{R}=13s case (10 min, FIG. 10A-iii). CO₂ conversion was also higher for the t_{R}=20s case, attaining 7.1% compared to 4.5% for the t_{R}=13s case. However, both the maximum liquid yield (110.8 wt %, FIG. 16F) and CO gas selectivity (87%, FIG. 17E) were lower for the t_{R}=20s case compared to the t_{R}=13s case, which had 120.7 wt % and 93%, respectively (FIG. 10A-iii and FIG. 10B-iii). The liquid produced using this condition was slightly less oxygenated (Table 3). However, the individual selectivities of alcohols, carboxylic acids, and other carbonyls in the liquid were 78.4, 4.8, and 2% (total 85.2%, FIG. 18E), indicating the liquid products are also predominantly fatty alcohols.

The synergistic enhancement of CO₂ conversion by PE was compared for different plasma conditions in FIG. 19. Synergy was confirmed for all the cases, although the extent of increase in CO₂ conversion due to PE depended on the reaction parameters. These findings highlight the intricate balance among PE conversion rate, product yields, product selectivity, and CO₂ conversion affected by various experimental parameters, underlining the importance of optimizing these parameters to tailor the desired products.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method of decomposing a polymeric reactant comprising:
reacting the polymeric reactant in an oxygen containing ionized gas plasma to decompose the polymeric reactant and produce oxygen-functionalized products, wherein said reacting is carried out at a temperature of 20 to 450° C.

2. The method of claim 1, wherein said reacting is carried out in an electric field.

3. The method of claim 2, wherein said reacting is carried out in a plasma reactor operating at a voltage of 10 to 20 kV.

4. The method of claim 2, wherein said reacting is carried out in a plasma reactor operating at a frequency of 5 to 10 kHz.

5. The method of claim 2, wherein said reacting is carried out for 2 to 60 minutes.

6. The method of claim 1, wherein said oxygen-functionalized products are selected from the group consisting of alcohols, carboxylic acids, esters, carbonyls other than carboxylic acids and esters, and mixtures thereof.

7. The method of claim 1 further comprising:
heating the polymeric reactant prior to said reacting to a temperature sufficient to convert the polymeric reactant to a condensable vapor form but insufficient to decompose the polymeric reactant from its polymeric state.

8. The method of claim 7, wherein said heating is carried out at a temperature of 20 to 450° C.

9. The method of claim 7, wherein said heating is terminated once said reacting is initiated.

10. The method of claim 7, wherein said heating continues during said reacting.

11. The method of claim 1, wherein said oxygen containing ionized gas plasma is air.

12. The method of claim 1, wherein said oxygen containing ionized gas plasma is oxygen.

13. The method of claim 1, wherein said oxygen containing ionized gas plasma comprises carbon dioxide.

14. The method of claim 1, wherein said oxygen containing ionized gas plasma comprises carbon monoxide.

15. The method of claim 1, wherein the polymeric reactant is a polyolefin.

16. The method of claim 15, wherein the polyolefin is selected from the group consisting of polyethylene, polypropylene, polybutylene, polystyrene, and mixtures thereof

17. The method of claim 1, wherein the oxygen-functionalized products are in liquid and/or wax form.

18. The method of claim 1, wherein the ionized gas plasma comprises energetic electrons, protons, ions, radicals, molecules, and/or atoms.

19. The method of claim 1, wherein said reacting is carried out with a catalyst.

20. The method of claim 19, wherein said catalyst is a solid catalyst selected from the group consisting of zeolite catalysts, metal catalysts, metal oxides, bi-functional catalysts, and mixtures thereof.

21. A method of removing carbon dioxide and/or carbon monoxide from a gas mixture comprising:
providing a gas mixture comprising carbon dioxide and/or carbon monoxide and
contacting the gas mixture with a polymeric reactant in an ionized gas plasma to remove carbon dioxide and/or carbon monoxide from the gas mixture and produce oxygen-functionalized products.

22. The method of claim 21 wherein the gas mixture further comprises oxygen.

23. The method of claim 21, wherein said oxygen-functionalized products are selected from the group consisting of alcohols, carboxylic acids, esters, carbonyls other than carboxylic acids and esters, and mixtures thereof.

24. The method of claim 21, wherein said gas mixture comprises carbon dioxide.

25. The method of claim 21, wherein said gas mixture comprises carbon monoxide.

26. The method of claim 21, wherein the polymeric reactant is a polyolefin.

27. The method of claim 26, wherein the polyolefin reactant is selected from the group consisting of polyethylene, polypropylene, polybutylene, polystyrene, and mixtures thereof.

28. The method of claim 21, wherein the oxygen-functionalized products are in liquid and/or wax form.

29. The method of claim 21 wherein said contacting is carried out in an electric field.

30. The method of claim 29, wherein said contacting is carried out in a plasma reactor operating at a voltage of 10 to 20 kV.

31. The method of claim 29, wherein said contacting is carried out in a plasma reactor operating at a frequency of 5 to 10 kHz.

32. The method of claim 29, wherein said contacting is carried out for 2 to 60 minutes.

33. The method of claim 21, wherein the ionized gas plasma comprises energetic electrons, protons, ions, radicals, molecules, and/or atoms.

34. The method of claim 21, wherein said contacting is carried out with a catalyst.

35. The method of claim 34, wherein said catalyst is a solid catalyst selected from the group consisting of zeolite catalysts, metal catalysts, metal oxides, bi-functional catalysts, and mixtures thereof.
